(19) United States
(12) Patent Application Publication
(10) Pub. No.: US 2003/0058557 A1
(43) Pub. Date: Mar. 27, 2003

(54) Data demodulating method for magnetic recording data

(75) Inventors: Shinya Morozumi, Nagano (JP); Hiroshi Nakamura, Nagano (JP)

Correspondence Address: SUGHRUE MION, PLLC, 2100 Pennsylvania Avenue, NW, Washington, DC, 20037-3213, US

(73) Assignee: KABUSHIKI KAISHA SANKYO SEIKI SEISAKUSHO

(21) Appl. No.: 10/231,380

(22) Filed: Aug. 30, 2002

(30) Foreign Application Priority Data
Sep. 3, 2001 (JP) P2001-266164
Sep. 3, 2001 (JP) P2001-266286
Oct. 9, 2001 (JP) P2001-310975

(51) Int. Cl. G11B 25/04; G11B 5/02

(52) U.S. Cl. 360/29; 360/2

(57) ABSTRACT

The present invention relates to a stop section detecting method of various magnetic recording media such as a magnetic card and a data demodulating method for magnetic recording data in the case in which magnetic recording data written to the magnetic recording media are to be demodulated.

### BACKGROUND OF THE INVENTION

1. Field of the Invention

The present invention relates to a stop section detecting method of various magnetic recording media such as a magnetic card and a data demodulating method for magnetic recording data in the case in which magnetic recording data written to the magnetic recording media are to be demodulated.

2. Related Art

As shown in FIG. 1, for example, various recording and reproducing apparatuses for handling a magnetic recording medium such as a magnetic card are generally constituted in such a manner that magnetic recording data information (see FIG. 2(a)) having a combination of two kinds of frequencies (F, 2F) written to a magnetic recording medium 1 such as a magnetic card is reproduced as an analog signal through a magnetic head 2, the analog reproducing signal is caused to pass through two system amplifiers 3 and 3, and one of signals thus obtained (see FIG. 2(b)) is subjected to waveform shaping by a comparator 4 to acquire binary data (see FIG. 2(e)), and furthermore, a peak position generated in the magnetic inversion position of the analog reproducing signal is detected by a peak detecting circuit 5 including a differentiating circuit and an integrating circuit (see FIG. 2(c)) and is subjected to waveform shaping through a comparator 6 to be binary. In response to a peak interval signal thus obtained (see FIG. 2(d)), a timing signal (see FIG. 2(f)) corresponding to the peak output of the analog reproducing signal is generated from a timing generating circuit 7, and furthermore, is used for a data discriminating circuit or a CPU 8 to time a time interval between adjacent peak positions. Based on the interval data thus obtained, the magnetic recording data are demodulated.

At this time, in the data discriminating circuit or the CPU 8, a reference time αT is set to interval data T and the presence of the inversion of a signal polarity in the reference time αT is detected, thereby carrying out a binary discrimination to obtain demodulated data. In order to carry out the data demodulation, thus, there has conventionally been proposed a bit follow-up method shown in FIG. 18, for example, to cope with a fluctuation in a carrier speed in the case in which a magnetic recording medium such as a magnetic card is to be manually carried particularly in a recording and reproducing apparatus of a manual type. In this method, a reference time αTₖ₋₁ (1/2<α<1) is set by using last interval data Tₖ₋₁ for interval data Tₖ (k=1, 2, . . . ) of a bit to be a current demodulation object, and their values are compared with each other. According to the bit follow-up method, even if a carrier speed fluctuates so that the bit time interval of the reproducing signal is slightly changed, the generation of misreading can be prevented by calculating a reference signal from a last bit.

In some cases in which the passage speed of a magnetic recording medium such as a magnetic card is rapidly changed or the magnetic recording medium is stopped, however, a reading speed for the last interval data Tₖ₋₁ and a reading speed for the current interval data Tₖ in the bit follow-up method are considerably different from each other so that both data cannot be compared with each other and the demodulation cannot be carried out accurately.

Further, when the speed of the passage of a magnetic recording medium such as a magnetic card through the magnetic head 2 is rapidly reduced or the magnetic recording medium is stopped, however, an analog reproducing signal is changed by a magnetic inversion, that is, a peak value is decreased, and furthermore, the analog reproducing signal is changed, that is, a time interval between adjacent peak positions is increased. As a result, a peak detection cannot be carried out due to a small peak value in a differentiating circuit, for example, in some cases. In the case in which an integrating circuit is used, moreover, a low-frequency signal is cut so that the peak of a signal having a long time interval cannot be detected, and a noise on the signal is stored so that a low-frequency noise appears and the peak detection cannot be carried out.

### SUMMARY OF THE INVENTION

Therefore, it is an object of the invention to provide a data demodulating method for magnetic recording data which can estimate and discriminate an error character easily and accurately also in the case in which the error character is generated in a plurality of portions due to the rapid change off the carrier speed of a magnetic recording medium or the stop thereof.

Therefore, it is another object of the invention to provide a data demodulating method for magnetic recording data which can accurately carry out normalization and can demodulate magnetic recording data well also in the case in which the carrier speed of a magnetic recording medium is rapidly changed or the magnetic recording medium is stopped with a simple structure.

Therefore, it is another object of the invention to provide a stop section detecting method for a magnetic recording medium and a data demodulating method for magnetic recording data which can carry out a demodulation accurately and stably with a simple structure, that is, can prevent an erroneous detection from being caused also in the case in which the carrier speed of the magnetic recording medium is reduced or the magnetic recording medium is stopped.

In order to achieve the object, a first aspect of the invention is directed to a data demodulating method for magnetic recording data, comprising the steps of discriminating a plurality of demodulated characters into normal characters having only proper bit signals which are demodulated properly and error characters at least partially including improper bit signals which are not demodulated properly, estimating each of the improper bit signals constituting the error characters by using the proper bit signals constituting the normal characters if the error characters are generated in a plurality of portions, and calculating the improper bit signals which cannot be estimated in one error character by using estimation bit signals capable of carrying out the estimation for other error characters, thereby discriminating all the error characters. According to the method having such a structure, also in the case in which the error character is generated in a plurality of portions, the improper bit signal constituting each error character is estimated as much as possible based on the proper bit signal of the normal character, and furthermore, the improper bit signal which cannot be estimated is calculated by using the estimation bit signal related to the other error characters.

Moreover, a second aspect of the invention is directed to the data demodulating method for magnetic recording data according to the first aspect of the invention, wherein the improper bit signal in the error character is estimated based on proper bit signals in normal characters adjacent to front and rear parts of the error character. Therefore, the improper bit signal in each error character is estimated at the maximum.

Furthermore, a third aspect of the invention is directed to the data demodulating method for magnetic recording data according to the second aspect of the invention, wherein the improper bit signal in the error character is estimated by a bit follow-up method using a plurality of normal bit signals or estimation bit signals which are adjacent to the improper bit signal.

Moreover, a fourth aspect of the invention is directed to the data demodulating method for magnetic recording data according to the third aspect of the invention, wherein an operation is carried out to adapt a plurality of adjacent bit signals to be used for the estimation of the improper bit signal in the error character to either of bit signals of “0” and “1”. Consequently, the improper bit signal in the error character can be estimated easily and accurately.

On the other hand, a fifth aspect of the invention is directed to the data demodulating method for magnetic recording data according to the first aspect of the invention, wherein when the improper bit signal which cannot be estimated in the error character is to be calculated by using the estimation bit signals in the other error characters, an operation is carried out based on a fact that a total number of bit signals of “1” in the same rank in all the characters is a predetermined even or odd number.

Moreover, a sixth aspect of the invention is directed to the data demodulating method for magnetic recording data according to the first aspect of the invention, wherein if a parity bit is not estimated with the characters from which the error characters are discriminated, the parity bit is calculated based on a relationship with other estimation bit signals in the discriminated characters.

Furthermore, a seventh aspect of the invention is directed to the data demodulating method for magnetic recording data according to the first aspect of the invention, wherein if the parity bit is estimated with the characters from which the error characters are discriminated, other estimation bit signals are checked by using the parity bit. Consequently, the bit signal which cannot be estimated in one error character can be calculated easily and accurately based on the bit signals estimated for the other error characters.

In order to achieve the object, an eighth aspect of the invention is directed to a data demodulating method for magnetic recording data, comprising the steps of sequentially connecting adjacent peak positions in a reproducing signal of magnetic recording data, thereby calculating a peak envelope, obtaining a speed curve corresponding to a relative moving speed of a magnetic recording medium and a magnetic head by using the peak envelope, calculating a mean speed of the peak positions in the reproducing signal of the magnetic recording data based on the speed curve, normalizing peak position interval data in the reproducing signal of the magnetic recording data by using the mean speed of the peak positions, and demodulating magnetic data information having “0” and “1” signals based on peak interval data obtained by the normalization.

More specifically, according to the data demodulating method for magnetic recording data in accordance with the eighth aspect of the invention having such a structure, the peak interval is normalized based on the speed curve obtained by the peak envelope acquired by connecting the peak positions in the reproducing signal of the magnetic recording data. Also in the case in which the relative moving speed of the magnetic recording medium and the magnetic head fluctuates extremely, therefore, the normalization processing is carried out stably and accurately. By using the peak interval data thus normalized accurately, a speed fluctuation is removed well from original peak interval data so that the magnetic data information can be demodulated accurately.

In this case, an ninth aspect of the invention is directed to the data demodulating method for magnetic recording data according to the eighth aspect of the invention, wherein the number of data on the peak position in the reproducing signal of the magnetic recording data is reduced to carry out a reduction processing in order to calculate the peak envelope.

An tenth aspect of the invention is direct to the data demodulating method for magnetic recording data according to the ninth aspect of the invention, wherein a speed curve obtained by using the peak envelope subjected to the reduction processing is enlarged to have the number of data on an original peak position, thereby carrying out an interpolation processing. Consequently, abnormal data corresponding to the peak position which cannot be detected well due to a particularly considerable speed fluctuation are disregarded. As a result, it is possible to obtain a much more accurate speed curve.

Furthermore, an eleventh aspect of the invention is directed to the data demodulating method for magnetic recording data according to the tenth aspect of the invention, wherein the interpolation processing is carried out by a tertiary convolution interpolating method. Consequently, the interpolation processing can be carried out easily with high precision.

In order to achieve the object, a twelfth aspect of the invention is directed to a method of detecting a stop section of a magnetic recording medium, comprising the steps of carrying out an integral calculation of a reproducing signal of magnetic recording data, thereby obtaining an integral waveform, and detecting an amplitude or a cycle of a peak fluctuation in the integral waveform and deciding, as a stop section of a relative movement of a magnetic recording medium and a magnetic head, a range in which the amplitude or cycle of the peak fluctuation thus detected is smaller than a threshold corresponding to an amplitude or a cycle of a peak fluctuation obtained when the relative movement is stopped.

More specifically, according to the method of detecting a stop section of a magnetic recording medium in accordance with the twelfth aspect of the invention having such a structure, the stop section is discriminated based on the amplitude or cycle of the peak fluctuation in the integral waveform. Consequently, a malfunction can be prevented well in the stop section.

Moreover, a thirteenth aspect for the invention is directed to a data demodulating method of magnetic recording data, comprising the steps of carrying out an integral calculation of a reproducing signal of magnetic recording data, thereby obtaining an integral waveform, detecting an amplitude or a cycle of a peak fluctuation in the integral waveform and deciding, as a stop section of a relative movement of a magnetic recording medium and a magnetic head, a range in which the amplitude or cycle of the peak fluctuation thus detected is smaller than a threshold corresponding to an amplitude or a cycle of a peak fluctuation obtained when the relative movement is stopped, and carrying out no demodulation over magnetic data information in the stop section. More specifically, according to the data demodulating method for magnetic recording data in accordance with the fourth aspect of the invention having such a structure, the stop section is discriminated based on the amplitude or cycle of the peak fluctuation in the integral waveform and the magnetic data information is not demodulated in the stop section. Consequently, the peak detection for the magnetic recording data can be carried out accurately irrespective of the stop section so that the erroneous detection of a character can be prevented well.

Furthermore, a fourteenth aspect of the invention is directed to the data demodulating method for magnetic recording data according to the thirteenth aspect of the invention, wherein in the demodulation of the magnetic data information based on the integral waveform, a zero cross point of the integral waveform is detected as a peak position in the reproducing signal of the magnetic recording data. By detecting the zero cross point of the integral waveform, it is possible to carry out a processing operation rapidly and accurately.

Moreover, a fifteenth aspect of the invention is directed to the data demodulating method for magnetic recording data according to the thirteenth aspect of the invention, wherein the magnetic data information is demodulated based on the integral waveform of the reproducing signal of the magnetic recording data in such a range that the reproducing signal of the magnetic recording data is smaller than a properly determined output level. Consequently, a useless integral processing in a high output level section is omitted and a processing is carried out for only a signal within a low output level range in which the detection cannot be carried out by a conventional method. Thus, a whole time required for a peak detection can be shortened.

On the other hand, a sixteenth aspect of the invention is directed to the data demodulating method for magnetic recording data according to the thirteenth aspect of the invention, wherein in the demodulation of the magnetic data information based on the integral waveform, first of all, the reproducing signal of the magnetic recording data is A/D converted to obtain a reproduction curve of digital data, an integral calculation for the digital data forming the reproduction curve is carried out to obtain an integral waveform, a curve representing a mean value of the integral waveform is then obtained by using a maximum value and a minimum value in the integral waveform, a mean integral curve is further obtained by subtracting the mean value from the value of the integral waveform, and a zero cross point of the mean integral curve is detected as a peak position in the reproducing signal of the digital data, thereby demodulating the magnetic data information.

According to the data demodulating method for magnetic recording data having such a structure, a signal obtained by carrying out the integral calculation over the digitized reproducing signal is used. Consequently, the peak detection can be carried out in a signal having a low level to have a detectable level. Also in the case in which the passage speed of the magnetic recording medium such as a magnetic card is reduced so that the detection cannot be conventionally carried out, therefore, the peak detection can be performed well. Moreover, only a low-frequency noise is removed based on the mean value of the integral waveform without uniformly cutting a low-frequency signal in the integral calculation. Also in the case in which a peak interval is greatly enlarged, therefore, the peak detection can be carried out well.

Furthermore, a fourteenth aspect of the invention is directed to the data demodulating method for magnetic recording data according to the thirteenth aspect of the invention, wherein an envelope on a maximum side and an envelope on a minimum side are obtained by using a maximum value and a minimum value in the integral waveform respectively, and a mean value of the integral waveform is obtained by using the envelope on the maximum side and the envelop on the minimum side. By using the envelope of the integral waveform, the mean value can be calculated rapidly so that a whole processing speed can be enhanced.

### BRIEF DESCRIPTION OF THE DRAWINGS

FIG. 1 is a block diagram illustrating the demodulating structure of a general magnetic card recording and reproducing apparatus;

FIG. 2 is a timing chart illustrating a procedure for executing a data demodulating method for magnetic recording data according to the conventional art;

FIG. 3 is a chart illustrating an example of the case in which the presence of the inversion of a signal polarity is detected by a bit follow-up method;

FIG. 4 is a block diagram showing a first embodiment of a data demodulating apparatus for magnetic recording data according to the invention;

FIG. 5 is a chart showing an example in a state in which a bit signal (interval) constituting a plurality of characters is detected;

FIG. 6 is a flowchart illustrating a procedure for a processing of estimating and discriminating an error character;

FIG. 7 is a typical diagram showing a state in which a plurality of error characters are detected and identified;

FIG. 8 is a chart illustrating the front side portion of an error character which is to be used in a procedure for bit follow-up from the front side;

FIG. 9 is a chart illustrating the front side portion of the error character in the middle process of the bit follow-up from the front side;

FIG. 10 is a chart illustrating the front side portion of the error character which is to be used in a procedure for obtaining a prediction range in the bit follow-up from the front side;

FIG. 11 is a chart illustrating the rear side portion of the error character which is to be used in the procedure for the follow-up from the rear side;

FIG. 12 is a chart illustrating an example of a state in which an estimation processing has been executed over all the error characters;

FIG. 13 is a chart illustrating a state in which a bit signal is fetched after a “0” and “1” discrimination for one error character is carried out;

FIG. 14 is a chart illustrating a state in which a bit signal is fetched after a “0” and “1” discrimination for other error characters is carried out;

FIG. 15 is a typical diagram illustrating a state in which a temporary normal character is created from a plurality of estimated error characters;

FIG. 16 is a typical diagram illustrating a state in which an estimation character is created by using the temporary normal character;

FIG. 17 is a typical diagram illustrating a state in which one error character is interpolated by using the estimation character;

FIG. 18 is a typical diagram illustrating a state in which other error characters are interpolated by using the estimation character;

FIG. 19 is a block diagram showing an embodiment of a data demodulating apparatus for magnetic recording data according to the second embodiment of the present invention;

FIG. 20 is a chart showing an example of a digital reproducing signal (AMP reproducing signal) of detected magnetic recording data;

FIG. 21 is a chart showing a state in which a peak envelope of peak interval data in FIG. 20 is obtained;

FIG. 22 is a chart in which the peak envelope obtained in FIG. 21 is fetched;

FIG. 23 is a chart showing a reduced peak envelope in a track 1;

FIG. 24 is a chart showing a reduced peak envelope in a track 2;

FIG. 25 is a chart showing a reduced peak envelope in a track 3;

FIG. 26 is a chart showing a state in which the peak envelopes in the tracks are synthesized;

FIG. 27 is a chart showing a state in which the synthesized peak envelope is increased to have an original data number;

FIG. 28 is a chart in which the peak interval data in the reproducing signal of the magnetic recording data are plotted;

FIG. 29 is a chart in which a mean speed in each peak interval is obtained;

FIG. 30 is a chart showing peak interval data obtained after normalization;

FIG. 31 is a chart showing an example of the relationship between a peak interval column and a character;

FIG. 32 is a table showing an example of a peak interval value to be an error character;

FIG. 33 is a chart showing a peak interval column based on a peak interval value in FIG. 25;

FIG. 34 is a flow showing a procedure for the peak interval number determination processing of the error character;

FIG. 35 is a block diagram illustrating an example of a data demodulating apparatus for magnetic recording data to be used for carrying out the invention,

FIG. 36 is a detailed block diagram illustrating an enlarged A/D converting portion in the data demodulating apparatus shown in FIG. 1,

FIG. 37(a) is a diagram showing a peak interval signal obtained from an analog reproducing signal and

FIG. 37(b) is a diagram showing the digital data of the analog reproducing signal,

FIG. 38 is a flow chart showing an embodiment of a data demodulating method for magnetic recording data according to the invention,

FIG. 39 is a chart showing a reproduction curve in which a DC component is removed from a digital reproducing signal,

FIG. 40 is a chart showing the result of an addition for the reproduction curve illustrated in FIG. 39,

FIG. 41 is a chart showing an envelope and a mean curve in the addition curve illustrated in FIG. 40,

FIG. 42 is a chart showing the result of a subtraction of the mean curve from the addition curve illustrated in FIG. 40,

FIG. 43 is a chart showing a state in which a stop section is discriminated,

### DETAILED DESCRIPTION OF THE PREFERRED EMBODIMENTS

An embodiment in which the invention is used for reading a magnetic card will be described below in detail with reference to the drawings.

First embodiment

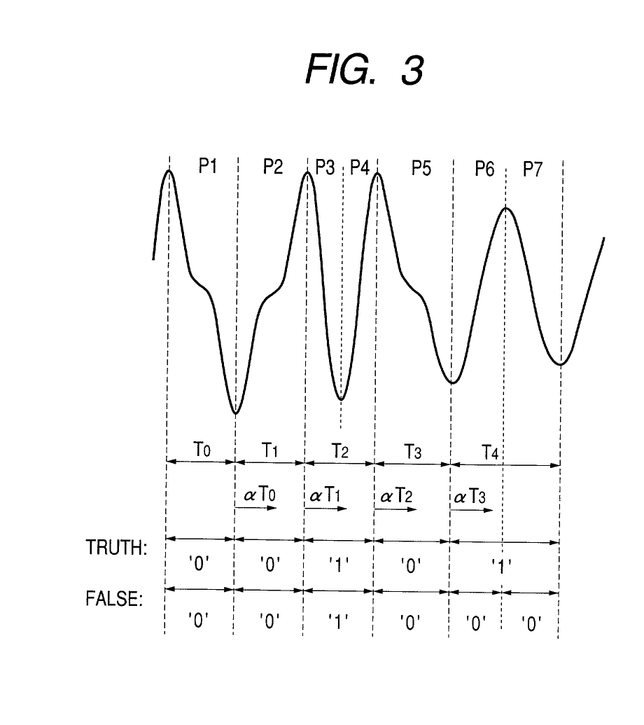

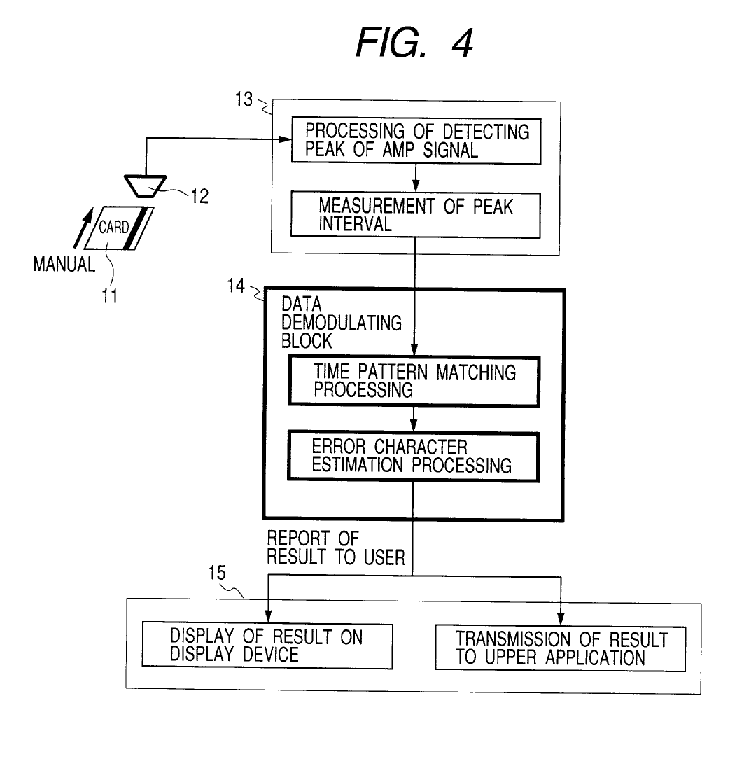

First embodiment of the present invention as shown in FIG. 4, magnetic recording data (see FIG. 2(a)) written to a magnetic card 11 to be a magnetic recording medium are reproduced as an analog signal (an AMP signal) by a relative movement with a magnetic head 12 when the magnetic card 11 is carried manually or automatically in a running passage which is not shown. The analog reproducing signal (AMP reproducing signal) is used in an F2F generating circuit and an F2F waveform discrimination interval measuring circuit which are provided in an ordinary peak detecting portion 13 having the same structure as that of the conventional art and an interval between adjacent peak positions is measured so that a peak interval detection signal (see FIG. 2(f)) thus obtained is output.

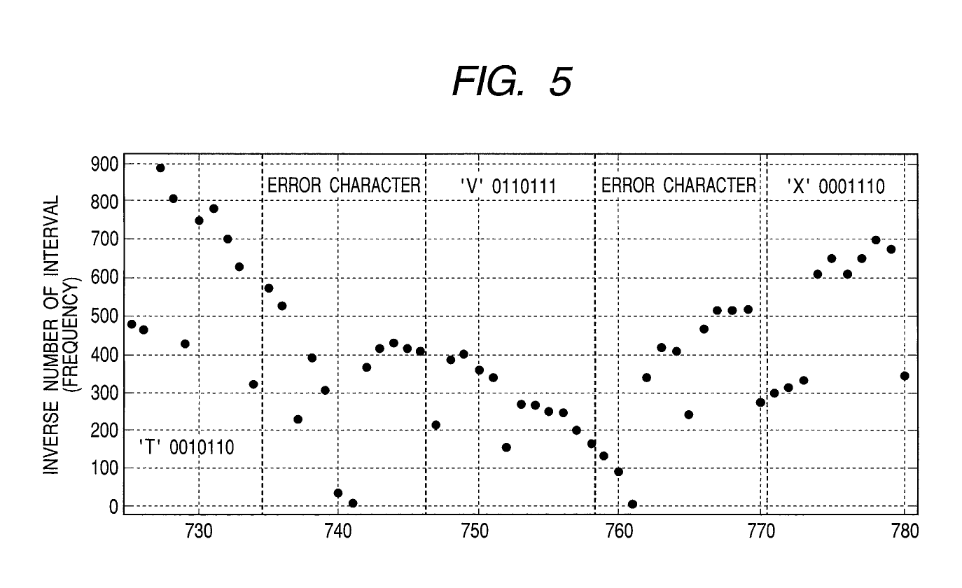

Referring to the peak interval detection signal thus obtained, a frequency (an axis of ordinate) for an acquired data number (an axis of abscissa) forms data comprising 2F having a great peak interval constituting a “1” signal and 1F of a small peak interval constituting a “0” signal as shown in FIG. 5 represented by a frequency to be an inverse number of the peak interval, and basically, the great peak interval is twice as much as the small peak interval, and the “1” signal is represented by two great peak intervals and the “0” signal is represented by one small peak interval. In FIG. 5, a portion in which the frequency is rapidly reduced corresponds to the case in which the passage speed of the magnetic card 11 is suddenly changed or the magnetic card 11 is stopped.

In the peak interval data, one character is represented by a 7-bit signal and the 7-bit signal includes a 1-bit parity bit signal. The peak interval data are fetched into a data demodulating block 14 in FIG. 4 and a time pattern matching processing is carried out by using various characters such as letters of A, B and C prepared in the apparatus.

In the time pattern matching processing, each character is read. In the case in which an error character at least partially including an improper bit signal which is not properly demodulated due to the sudden change of the passage speed of the magnetic car 11 or the stop thereof is present in a plurality of portions, a processing of estimating and discriminating each error character is carried out. Magnetic data information restored by the estimation and discrimination processing is externally displayed or transmitted in a proper data using portion 115 in FIG. 4.

Next, the procedure for the processing of estimating and discriminating the error character will be described specifically.

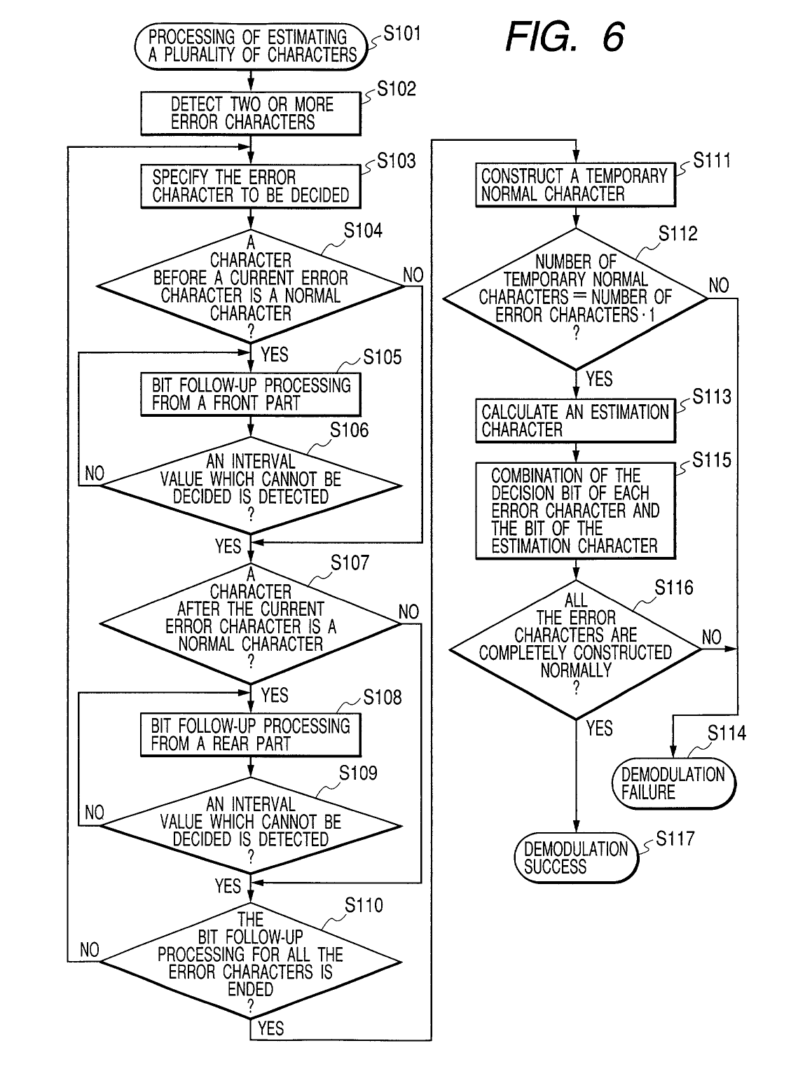

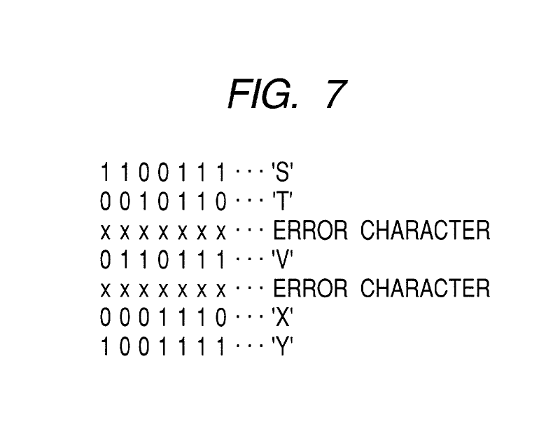

As shown in FIG. 6, when the processing of estimating and discriminating a plurality of characters is started (a step 101 in FIG. 6), a normal character comprising a proper bit signal which is wholly demodulated properly and an error character at least partially including an improper bit signal which is not demodulated properly are first identified based on the time pattern matching processing. FIG. 7 shows an example of a state obtained after the characters are identified. In the case in which an error character is generated in a plurality of portions, each of the improper bit signals constituting the error characters is estimated by using the proper bit signal constituting the normal character, thereby estimating and discriminating the error character based on peak interval data which cannot be read.

More specifically, as shown in FIG. 7, when the error character generated in a plurality of portions is detected (a step 102 in FIG. 6), one error character to be subjected to the estimation and discrimination processing is specified (a step 103 in FIG. 6). If an adjacent character on the front side prior to one error character thus fetched is a normal character (Yes in a step 104 of FIG. 6), a bit follow-up processing is executed from the front side in the following manner (a step 105 in FIG. 6).

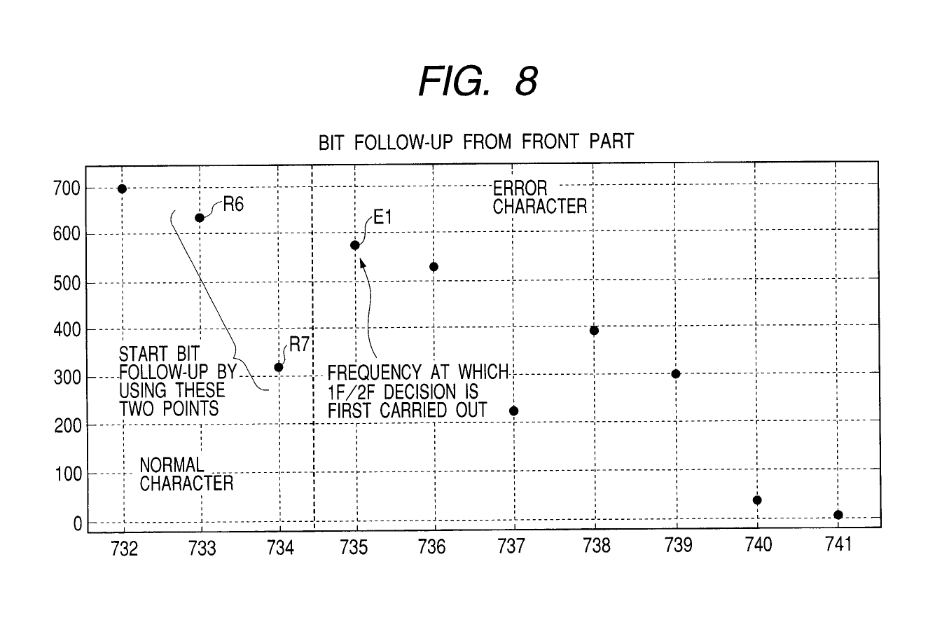

In the bit follow-up processing from the front side, as shown in FIG. 8, each improper bit signal constituting a specified error character is first estimated by using a proper bit signal in a normal character adjacent to a last part (front part) of the error character and a 1F/2F discrimination for the estimation bit signal is carried out. More specifically, a first improper bit signal E1 in the error character is obtained from the positional relationship between two final proper bit signals R6 and R7 of the normal character which continue to a last part of the improper bit signal E1.

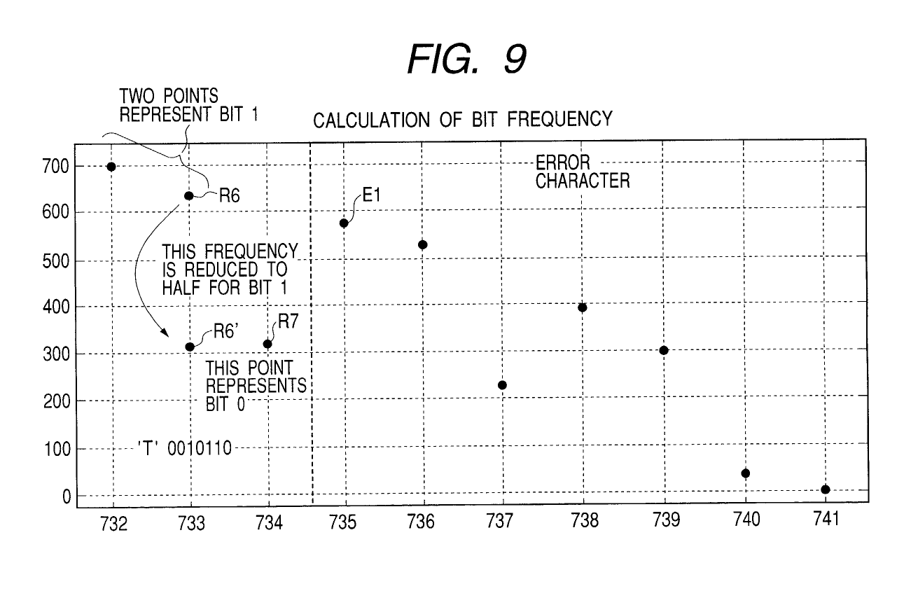

In other words, a frequency is calculated such that the two final proper bit signals R6 and R7 in the normal character are adapted to either of the “0” and “1” bit signals. In the embodiment, as shown in FIG. 9, the proper bit signal R7 on the rear side which has the frequency 1F is exactly maintained and the frequency 2F of the proper bit signal R6 on the front side is reduced to a half, and a virtual bit signal R6′ is thus obtained by an operation. The virtual bit signal R6′ is substantially set to have 1F.

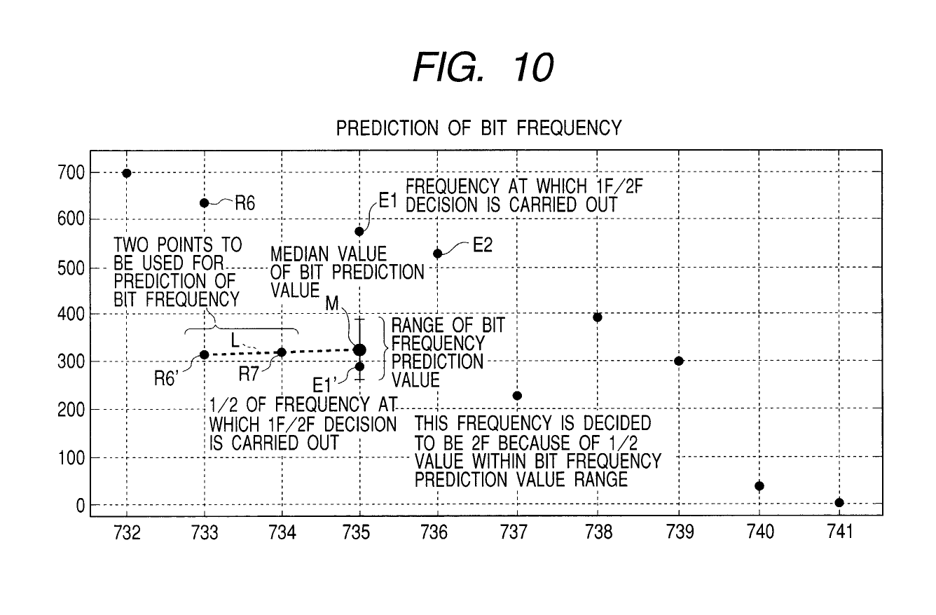

As shown in FIG. 10, next, a straight line L connecting the virtual bit signal R6′ and the proper bit signal R7 is extended toward the error character side (the right side in the drawing), and a median value M in a bit frequency prediction range is calculated in a position corresponding to the improper bit signal E1 on the extension of the straight line L. In this case, the following equation is employed, for example:

Median value M of bit frequency prediction range=(frequency of proper bit signal R7×2)−(frequency of virtual bit signal R6′).

Moreover, an actual prediction range for the median value M of the bit frequency prediction range thus calculated is set to be a range in which ±20% is estimated for the median value M of the bit frequency prediction range, that is,

bit frequency prediction range>median value M×0.8 and

bit frequency prediction range<median value M×1.2.

Then, it is checked whether any of the frequency of the improper bit signal E1 of the error character to be a current specification object and a half of the frequency is present within the bit frequency prediction range. If the frequency of the improper bit signal E1 itself is present within the bit frequency prediction range, the frequency of the improper bit signal E1 is estimated to be 1F. If a point E1′ in which the frequency of the improper bit signal E1 is reduced to a half is present within the bit frequency prediction range as shown in FIG. 10, the frequency of the improper bit signal E1 is discriminated to be 2F.

By such a procedure, a first improper bit signal E1 of the specified error character is estimated and a second improper bit signal E2 is estimated in the same manner by utilizing the estimated value of the first improper bit signal E1. The same estimating procedure as described above is repeated until the estimation processing cannot be carried out. When the estimation cannot be carried out (Yes in a step 106 of FIG. 6), the processing of estimating and discriminating an improper bit signal from the front side is ended.

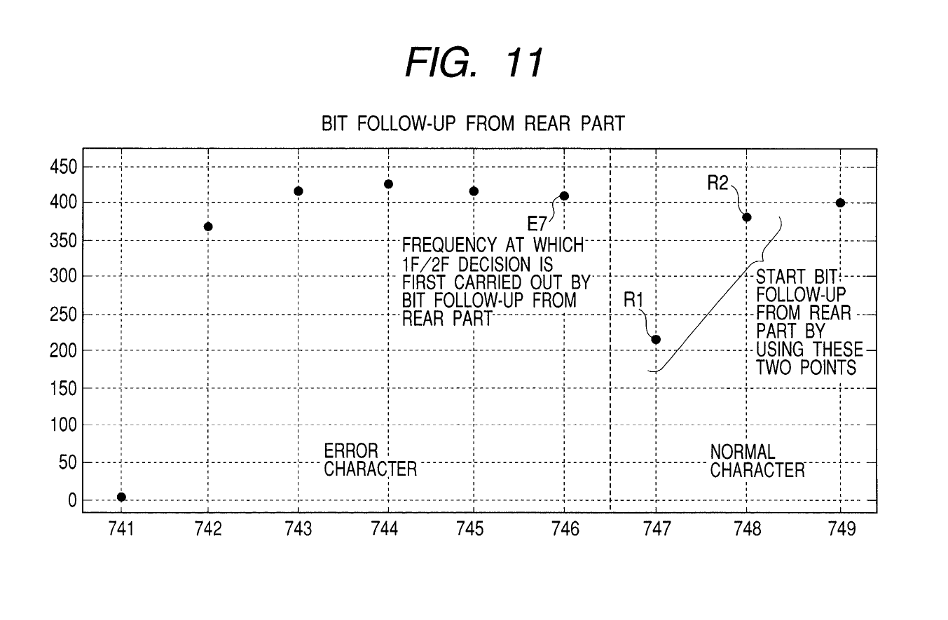

Next, if an adjacent character on the rear side continuing just immediately after the currently specified error character is a normal character (Yes in a step 107 of FIG. 6), a processing of estimating and discriminating a last improper bit signal E7 from the rear side opposite to the processing of estimating and discriminating an improper bit signal from the front side is started in the opposite direction by using two first proper bit signals R1 and R2 of a normal character continuing immediately after the improper bit signal E7 (a step 108 in FIG. 6) as shown in FIG. 11, and the same estimating procedure is repeated until the estimation cannot be carried out (a step 109 in FIG. 6). Then, when the discrimination cannot be carried out (Yes in the step 109 of FIG. 6), the processing of estimating an improper bit signal from the rear side is ended (a step 110 in FIG. 6).

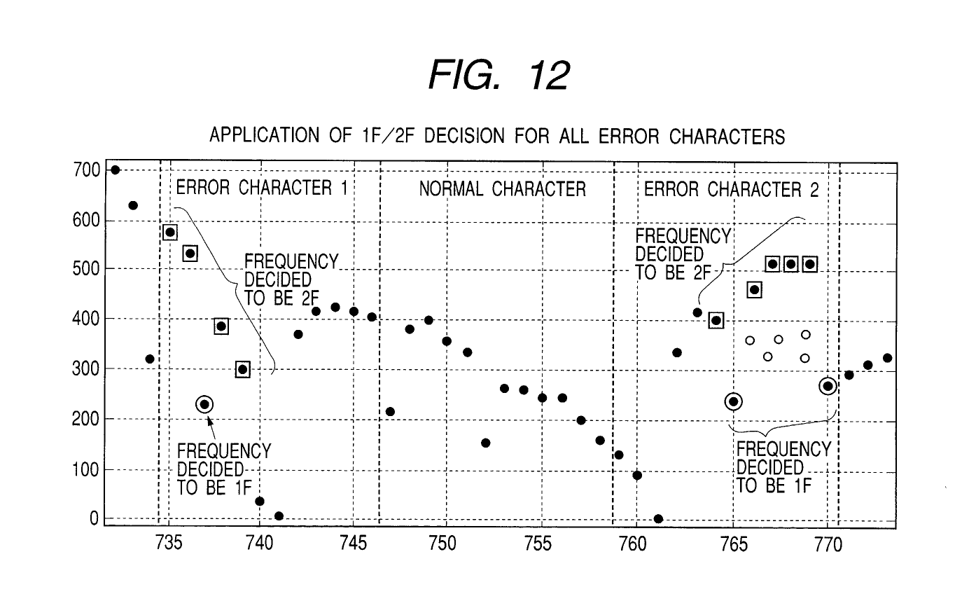

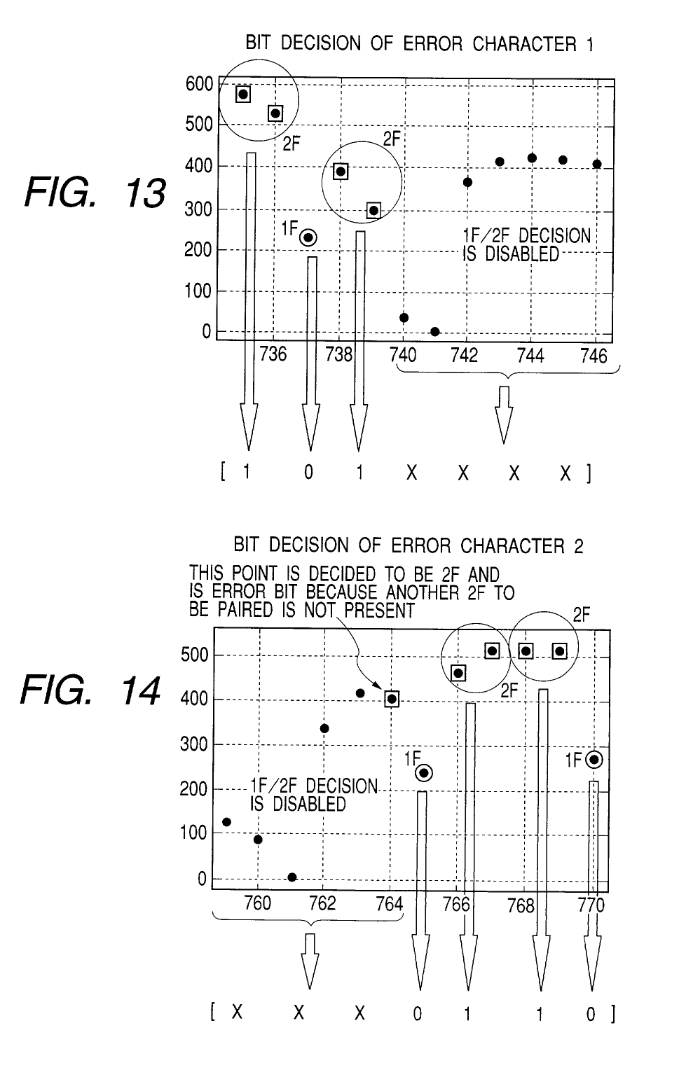

Subsequently, the estimation processing using the bit follow-up is carried out over the improper bit signals of all the error characters, and the 1F/2F discrimination processing is thereafter executed. FIG. 12 shows an example of a result obtained by the estimation and discrimination processing. Next, the bit signals capable of being discriminated to be “0” or “1” are fetched from the result of the estimation and discrimination processing as shown in FIGS. 13 and 14. For example, if the bit signal to be 2F is present in an adjacent state in pairs as is surrounded by a circle in FIGS. 13 and 14, the bit signal is fetched as “1”. If only one bit signal is to be 2F, an error (x) is set. Referring to the bit signal to be 1F, one signal is fetched as “0”.

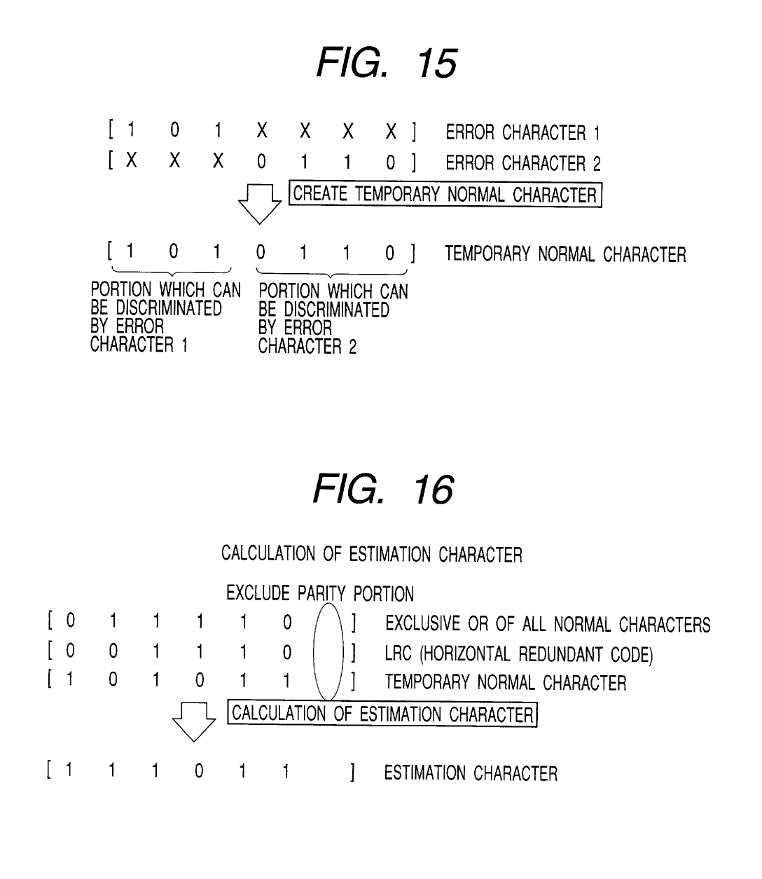

Furthermore, a character obtained by estimating each error character shown in FIG. 15 is created by using only the bit signal capable of being discriminated to be “0” or “1” as described above. Then, a temporary normal character embedding bit signals in all ranks is created by utilizing each error character which is estimated (a step 111 in FIG. 6). In the case in which the fetched bit signals in the same rank overlap in the creation of the temporary normal character, a preceding estimation error character is employed with priority.

If the number of the temporary normal characters thus created is smaller than the number of generated error character by one (Yes in a step 112 of FIG. 6), the processing proceeds to the calculation of the estimation character (a step 113 in FIG. 6). If not so, a decision of a demodulation failure is made (a step 114 in FIG. 6). Also in the case in which any bit signal cannot be embedded when the temporary normal character is to be created, moreover, it is decided that the estimation cannot be carried out and the processing is thus stopped. In the case in which a candidate can be consistently narrowed down to one from the LRC (horizontal redundant code) or the parity bit signal for a portion in which the bit signal cannot be embedded, however, the demodulation can be executed continuously.

When an estimation character is to be calculated (a step 113 in FIG. 6), one estimation character is led out by using all ordinary normal characters, the temporary normal character and the LRC (horizontal redundant code) as shown in FIG. 16. At this time, the operation is carried out based on the fact that the total number of the bit signals of “1” in the same rank in all the characters is a predetermined even or odd number. The parity bit of the LRC (horizontal redundancy code) is used for detecting the parity of the LRC itself. Therefore, the operation is carried out excluding the parity portion.

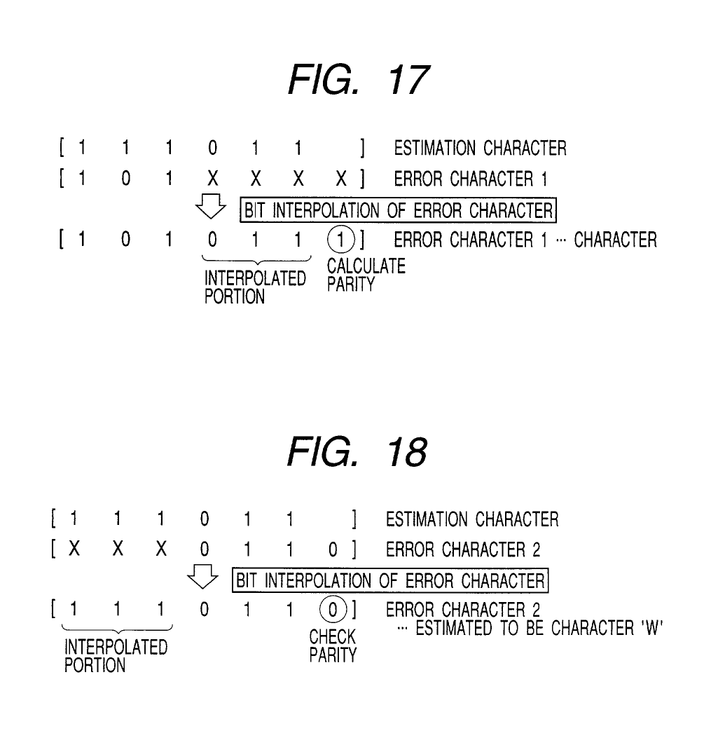

By using the estimation character thus obtained, an improper bit signal portion missing in the error character which cannot be discriminated to be “0” or “1” is interpolated as shown in FIGS. 17 and 18 (a step 115 in FIG. 6). At this time, the interpolation is carried out based on the fact that the total number of the bit signals of “1” in the same rank in all the charactersis a predetermined even or odd number. Then, when the discrimination of all the error characters is normally ended (a step 116 in FIG. 6), it is decided that the demodulation is successful and the procedure is thus ended (a step 117 in FIG. 6).

At this time, in the case in which the parity bit is not estimated in the interpolated and restored character as shown in FIG. 17, the parity bit is calculated based on each bit signal of the restored character. Moreover, in the case in which the parity bit is estimated in the character obtained by restoring the error character as shown in FIG. 18, each of other bit signals is checked by using the parity bit. If there is no inconsistency, it is decided that the demodulation is successful.

According to the method in accordance with the embodiment having such a structure, also in the case in which an error character is generated in a plurality of portions, an improper bit signal constituting each error character is estimated as much as possible based on the proper bit signal of a normal character, and furthermore, an improper bit signal which cannot be estimated is calculated by using an estimation bit signal for other error characters.

In the embodiment, moreover, the improper bit signal in the error character is estimated based on the proper bit signals of the normal characters which are adjacent to the front and rear parts of the error character. Therefore, the improper bit signal in each error character can be estimated at the maximum.

In the method according to the embodiment, moreover, the improper bit signal in the error character is estimated by the bit follow-up method using a plurality of normal bit signals or estimation bit signals which are adjacent to the improper bit signal, and furthermore, the operation is carried out to adapt a plurality of adjacent bit signals to be used for estimating the improper bit signal in the error character to either of the “0” and “1” bit signals. Consequently, the improper bit signal in the error character can be estimated easily and accurately.

In addition, in the method according to the embodiment, when the improper bit signal which cannot be estimated in one error character is to be calculated by using the estimation bit signals in other error characters, the operation is carried out based on the fact that the total number of the bit signals of “1” in the same rank in all the characters is a predetermined even or odd number. In the case in which the parity bit is not estimated by the character obtained by discriminating the error character, moreover, the parity bit is calculated based on the relationship with the other estimation bit signals of the discriminated character. In the case in which the parity bit is estimated by the character obtained by discriminating the error character, furthermore, the other estimation bit signals are checked by using the parity bit. Consequently, the bit signal which cannot be estimated in one error character can be calculated easily and accurately based on the bit signals estimated for the other error characters.

While the embodiment of the invention made by the inventor has been specifically described, the invention is not restricted to the embodiment but can be variously changed without departing from the scope thereof.

While two proper bit signals are utilized in each of the front and rear parts of the improper bit signal to be estimated, the number of the proper bit signals to be utilized is not restricted to two but three or more proper bit signals may be utilized. In that case, a curve passing through each bit signal is calculated and a point on the curve thus calculated can also be set to be an estimation bit signal.

Moreover, while ±20% of the calculated median value M is estimated to set the bit frequency prediction range in the embodiment, the conditions can be increased to reduce the possibility of misreading or the conditions can also be decreased to cope with a fluctuation in a speed within a wide range.

Furthermore, while each bit signal of the error characters which can be discriminated to be “0” or “1” by the bit follow-up is used for the estimation in the embodiment, these information can also be used for checking whether or not misreading is carried out after the estimation processing.

Second embodiment

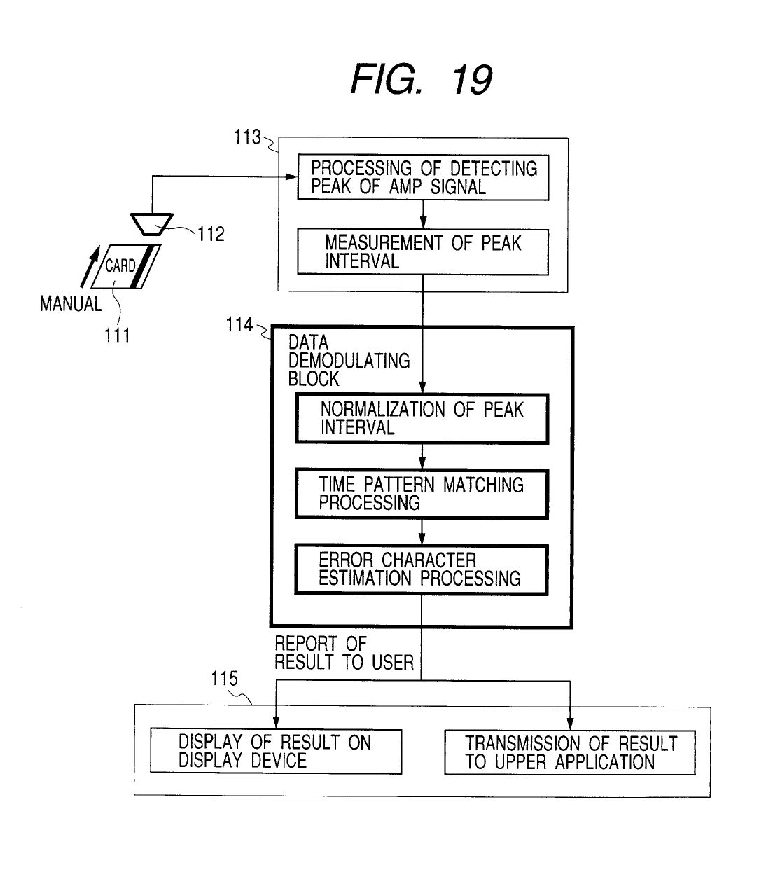

In a second embodiment of the present invention shown in FIG. 19, magnetic recording data (see FIG. 2(a)) written to a magnetic card 11 to be a magnetic recording medium are reproduced as an analog signal (an AMP signal) by a relative movement with a magnetic head 112 when the magnetic card 11 is carried manually or automatically in a running passage which is not shown. The analog reproducing signal (AMP reproducing signal) is used in an F2F generating circuit and an F2F waveform decision interval measuring circuit which are provided in an ordinary peak detecting portion 113 having the same structure as that of the conventional art and an interval between adjacent peak positions is measured so that a peak interval detection signal (see FIG. 2(f)) thus obtained is output.

The analog reproducing signal (AMP reproducing signal) thus obtained is input to a data demodulating portion 114 and is demodulated into magnetic data information having “0” and “1” signals, and the magnetic data information is externally displayed or transmitted in a proper data using portion 115.

In the data demodulating portion 114, a peak interval data normalization processing, a time pattern matching processing and an error character estimation processing according to the invention are sequentially carried out. First of all, description will be given to an embodiment of the peak interval data normalization processing according to the invention.

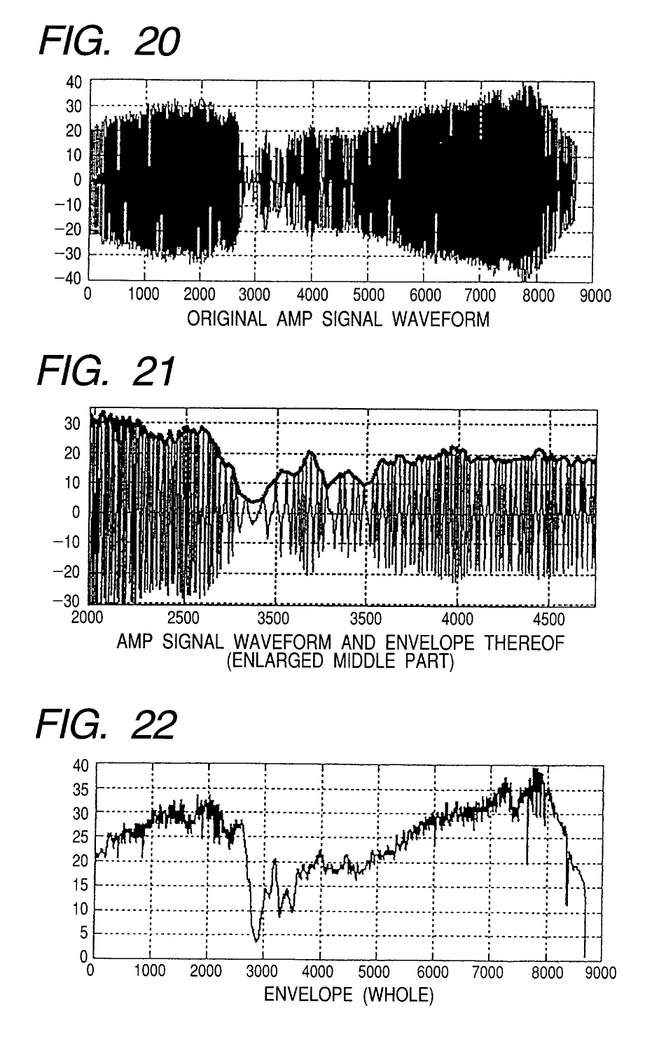

The analog reproducing signal (AMP reproducing signal) of the magnetic recording data is digitally converted to an amplifier signal waveform shown in FIG. 20. A digital reproducing signal has a value (an axis of ordinate in FIG. 20) corresponding to each of acquired data numbers (an axis of abscissa in FIG. 20 indicates the data number) in order. The absolute values of peak positions in the digital reproducing signal (AMP reproducing signal) are sequentially connected as shown in FIG. 21 so that a peak envelope based on a digital signal shown in FIG. 22 is calculated.

The peak envelope thus obtained is calculated for each magnetic recording data written to each of tracks of the magnetic card 11. In order to calculate a peak envelope for each track, the following data reduction processing is carried out. More specifically, in the reduction processing, a peak envelope created from the digital reproducing signal (AMP reproducing signal) of the magnetic recording data is first divided into small sections of approximately one-several tenth of a total data number, and a maximum value in each of the small sections is selected as a central value in the section so that the number of data is decreased. As a result, a reduced peak envelope for each of tracks 1, 2 and 3 which are the same as those obtained from original analog reproducing signals shown in FIGS. 23, 24 and 25 is calculated. In this case, if an interval between the small sections is set properly, an envelope created again by connecting the maximum values in the small sections can be close to the envelope of the original analog reproducing signal.

Next, the waveform shaping is carried out by setting the maximum value in the reduced peak envelope for each track to be “1”, and the reduced peak envelopes for the tracks 1, 2 and 3 thus obtained are synthesized. Consequently, a speed curve shown in FIG. 26 is obtained, for example. In order to synthesize the reduced peak envelopes, in the embodiment, the tracks 1 and 3 having comparatively stable data are mainly used. In a region in which a value is greater than a predetermined threshold, the mean value of both tracks 1 and 3 is employed as a synthesized value. In a region in which the value is smaller than the threshold, moreover, the minimum values of all the tracks 1, 2 and 3 are employed as the synthetic values.

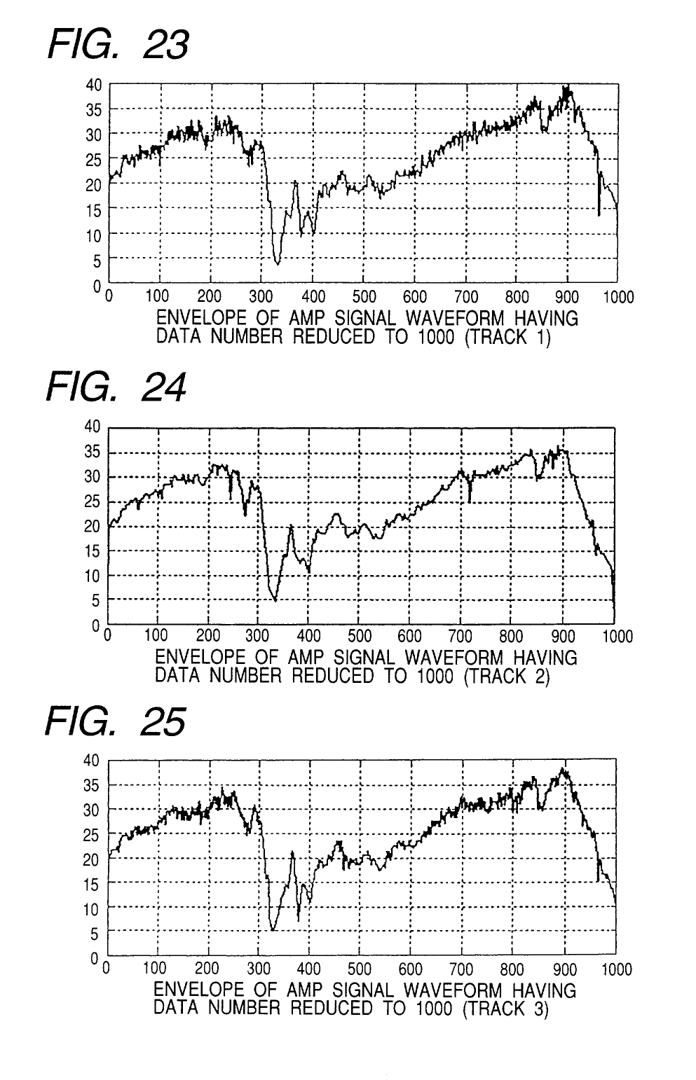

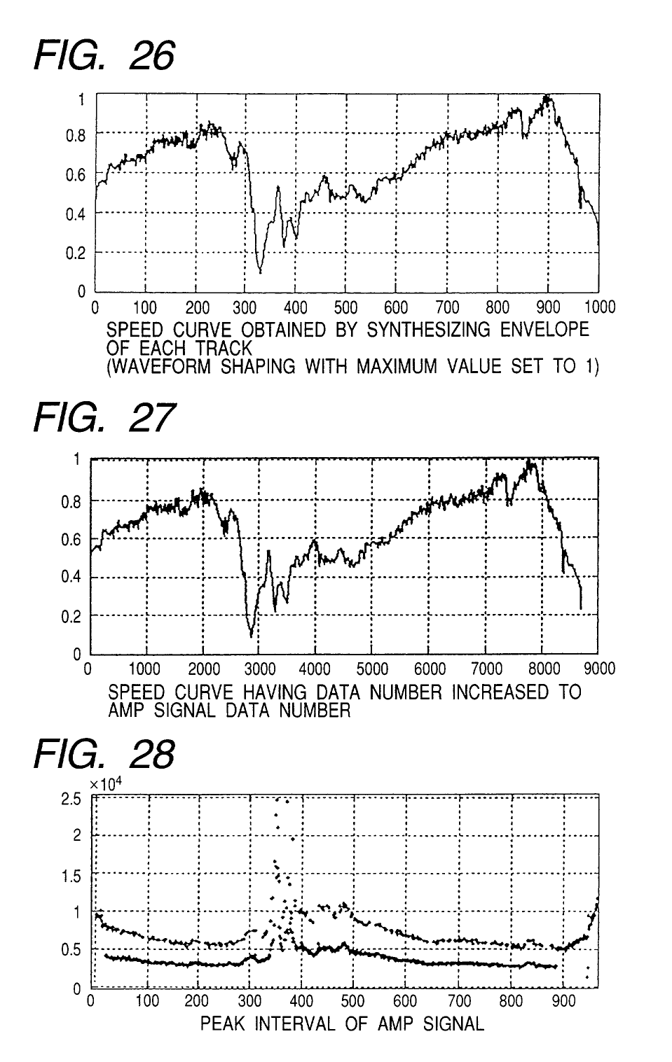

Next, the speed curve obtained by each peak envelope which is reduced as described above is increased to have an original data number as shown in FIG. 27 by one of well-known methods for adding a plurality of new points between original data, thereby estimating the sizes of the new points from the original data, for example, an interpolation processing using a so-called tertiary convolution interpolating method, and a curve having the data number increased is used as a final speed curve. Thus, the data subjected to the reduction processing by taking a maximum value in each small section are used and are subjected to the interpolation processing to be returned to have the same data number as that of the original data. Consequently, a peak envelope corresponding to an original analog reproducing signal can be obtained with high precision from the digital signal.

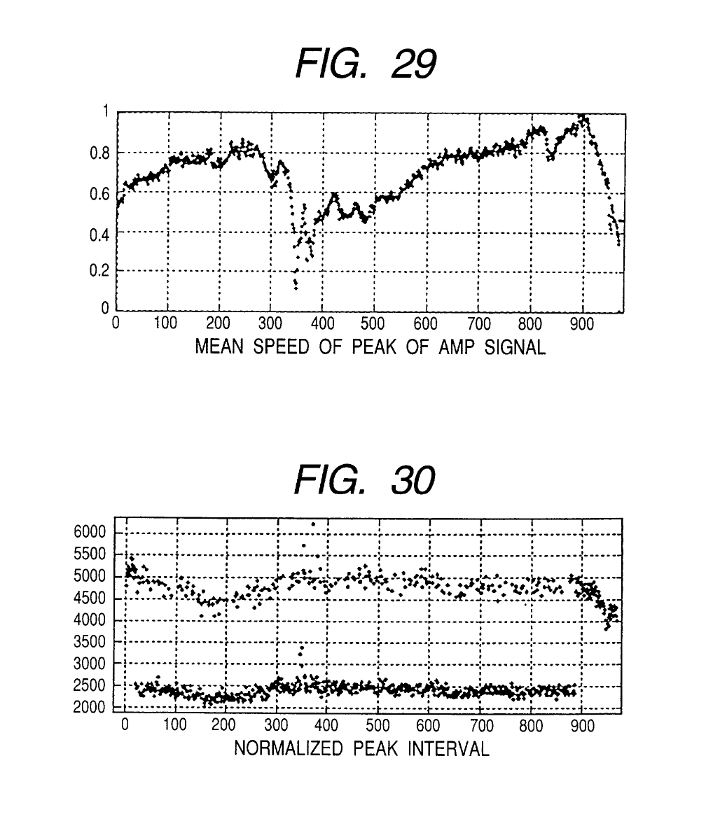

On the other hand, there are prepared peak interval data shown in FIG. 28, for example, which represents the relationship between the analog reproducing signal (AMP reproducing signal (see FIG. 20)) of the magnetic recording data and the peak interval corresponding to each of the peak positions. As shown in FIG. 29, for example, data on a mean speed between the peak positions are calculated from the speed curve (see FIG. 27) obtained as described above.

Next, the data on the peak interval (see FIG. 28) are multiplied by the data on the mean speed (FIG. 29), thereby carrying out normalization so that the original peak interval data are flattened as shown in FIG. 30. Thus, a value in the peak interval data thus normalized is corrected corresponding to a fluctuation in a speed. Therefore, the value is “1” or “0.5” indicative of the peak interval of the magnetic recording data written to the magnetic card 11 or is very close thereto. By using each of the values, an excellent reproduction state can be obtained.

In the embodiment, thus, the data on the original peak interval thus detected are subjected to the normalization processing. Consequently, the speed fluctuation in the magnetic card 1 is removed from the detected data on the original peak interval. Based on the data on the peak interval thus normalized, consequently, the magnetic data information is accurately demodulated. In the embodiment, particularly, the speed curve corresponding to the peak envelope connecting the peak positions in the reproducing signal of the magnetic recording data is employed for normalizing the peak interval. Also in the case in which the moving speed of the magnetic card 11 extremely fluctuates, therefore, the normalization processing is carried out stably and accurately. By using the peak interval data thus normalized accurately, the speed fluctuation is removed well from the original peak interval data so that the magnetic data information can be demodulated accurately.

In the embodiment, moreover, the reduction processing of reducing a data number related to the digital reproducing signal of the magnetic recording data described above is carried out in order to calculate the peak envelope, and furthermore, the speed curve obtained by using the peak envelope subjected to the reduction processing is increased to have the original data number, thereby carrying out the interpolation processing. Therefore, abnormal data corresponding to the peak position which cannot be detected well due to the particularly considerable speed fluctuation are disregarded. As a result, a much more accurate speed curve can be obtained.

In the embodiment, furthermore, the processing of interpolating the reduced data is carried out by the tertiary convolution interpolating method. Therefore, the interpolation processing can be carried out easily with high precision.

After the processing of normalizing the peak interval is thus carried out in the data demodulating portion 114 (see FIG. 19), the time pattern matching processing is carried out by using various characters such as letters A, B and C prepared in the apparatus based on the peak interval data subjected to the normalization processing. Consequently, the peak interval data are read, and furthermore, the processing of estimating the characters set in an error state is carried out. Thus, the character is estimated based on the peak interval data which cannot be read. A processing of estimating an error character will be described below.

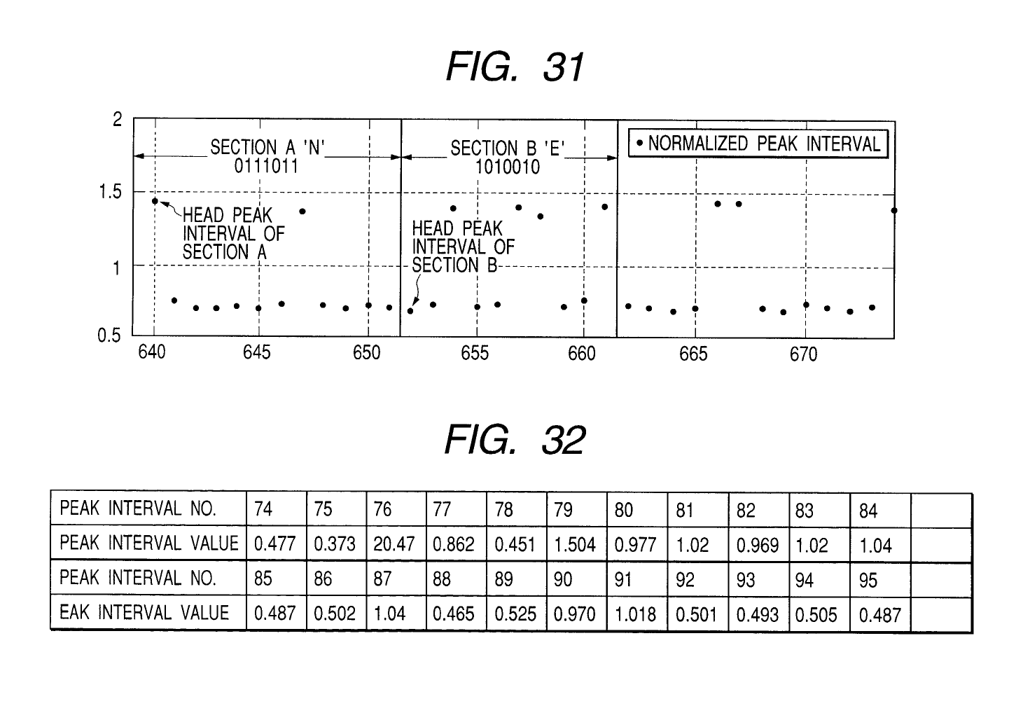

First of all, it is assumed that the character break of a peak interval column is present as shown in FIG. 31 if any, the peak interval column in a section A represents a character “N” (0111011) and the peak interval column in a section B indicates a character “E” (1010010). In each of the sections, a peak interval present on the left end side in FIG. 31 is a head peak interval. At this time, the number of the peak intervals included in each character is varied for each character (12 in the character “N” and 10 in the character “E”). For this reason, the head peak interval of a next character cannot be known as long as a last character is not defined. In other words, in FIG. 31, if the demodulation of the section A results in a failure and the section A is brought into an error character state, a peak interval corresponding to the head of the next interval B cannot be determined. In such a case, the processing is carried out in accordance with the following flow, thereby determining the number of peak intervals in the error character.

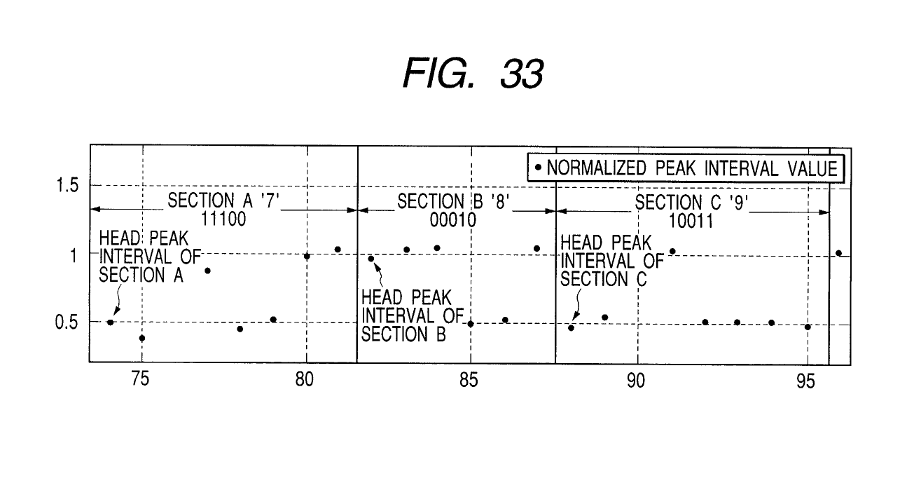

In FIG. 33 showing a state in which a peak interval column shown in FIG. 32 is plotted, characters “7”, “8” and “9” are read into sections A, B and C in FIG. 33, respectively. For example, it is assumed that the section A becomes an error character because a peak interval corresponding to a number “76” of the section A is not normally normalized due to the stop of a magnetic card during an operation for reading the peak interval having the same number.

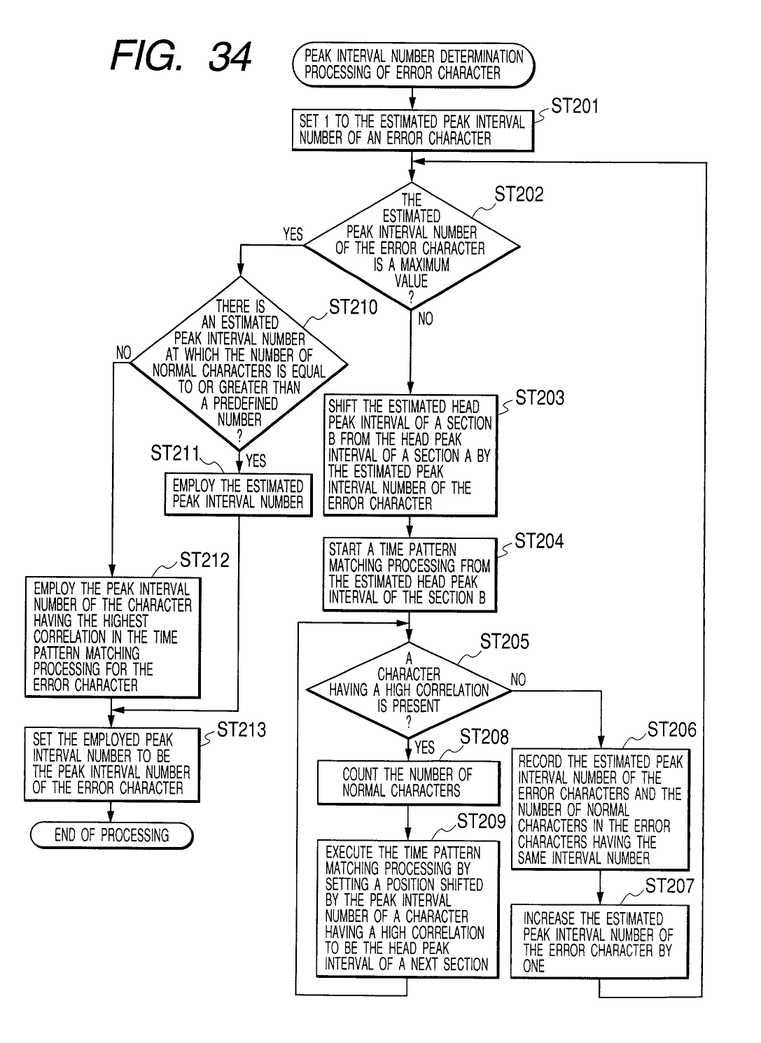

In this case, the processing of estimating an error character shown in FIG. 34 is carried out over the error character in the section A so that the head peak interval of the next section B is detected.

First of all, at a first step 201 (ST201) in FIG. 34, the estimated peak interval number of an error character is set to “1”. In this stage, the estimation interval number of the error character in a next step 202 (ST202) is not a maximum value. Therefore, the processing moves to a subsequent step 203 (ST203) in which a peak interval number of “75” obtained by shifting a number of “74” to be the head peak interval of the section A by the estimated peak interval number of “1” is set to be the head peak interval of the section B.

At a step 204 (ST204), then, a time pattern matching processing is carried out from the peak interval number of “75”. In the case in which a character having a high correlation cannot be found in a step 205 (ST205) as a result of the time pattern matching processing, the processing proceeds to a step 206 (ST206) in which the estimated peak interval number of “1” in this case and a normal character number of “0” are recorded.

At a next step 207 (ST207), the estimated peak interval number of the error character is set to “2” and the processing returns to the step 203 (ST203) through the step 202 (ST202), and the head peak interval of the section B is set to the peak interval number of “76”. Then, the time pattern matching processing in the step 204 (ST204) is carried out again in that position.

In the case in which the character having a high correlation cannot be found at the step 205 (ST205) as a result of the time pattern matching processing, the estimated peak interval number of “2” in that case and a normal character number of “0” are recorded at the next step 206 (ST206). Thus, the estimated peak interval number is gradually increased by one to sequentially shift the head peak interval of the section B, and the time pattern matching processing is thus repeated.

In the case in which the normal character number has a maximum of “1” even if the time pattern matching processing is repeated until the estimated peak interval number becomes “7”, for example, the estimated peak interval number is set to “8” and the head peak interval of the section B is thus set to have a peak interval number of “82”. As a result of the time pattern matching processing in that position, in the case in which characters having high correlations such as the sections B and C are found at the step 205 (ST205) and become error characters again or continue up to the position of a postamble, the normal character number of the estimated peak interval number of “8” is counted to set the number of characters having high correlations which can be found at a step 208 (ST208).

At a step 209 (ST209), subsequently, the estimated peak interval number is gradually increased by one from “9” again and a check is thus carried out up to a maximum value of 12 (the maximum peak interval number of the character of the track 2+2) in the same manner. When all the peak interval numbers are completely checked, the processing returns to the step 202 (ST202) again in which the numbers of the normal characters in the respective peak interval numbers are compared with each other. In the case in which the number of the normal characters is a maximum, the number of the normal characters which is equal to or greater than a predefined value is searched at a step 210 (ST210). In the example, the peak interval number of “8” is equivalent to the same number. Therefore, the peak interval number of the error character is set to “8” at a step 211 (ST211).

In the case in which any number of the normal characters is neither equal to nor greater than the predefined value, the peak interval number of a character having the highest correlation is employed at a step 212 (ST212), and furthermore, the peak interval number thus employed is set to be the peak interval number of the error character at a step 213 (ST213). Thus, the processing is ended.

While the embodiment of the invention made by the inventor has been specifically described above, the invention is not restricted to the embodiment but can be variously changed without departing from the scope thereof.

For example, while the maximum value of one section is employed for the central value of the same section in the case in which the reduction processing for the peak envelope is to be carried out in the embodiment, the invention is not restricted thereto but a mean value may be employed. Moreover, it is also possible to obtain a speed curve and a mean speed with an original data number without carrying out the reduction processing.

In order to synthesize the peak envelopes related to the tracks of a magnetic card, furthermore, it is also possible to carry out the synthesis by another method, for example, by calculating the mean value of all the tracks.

Moreover, while the tertiary convolution interpolating method has been employed for the interpolation processing to be carried out when enlarging the speed curve in the embodiment, it is also possible to employ other various methods such as a nearest interpolating method and a coprimary interpolating method.

Subsequently to the normalization described in the embodiment, moreover, it is also possible to carry out normalization using bit follow-up.

Furthermore, the acquired speed curve is not restricted to the normalization processing but can also be used for a processing of analyzing the running state of a magnetic card.

Third embodiment

An embodiment in which the invention is used for reading a magnetic card will be described below in detail with reference to the drawings.

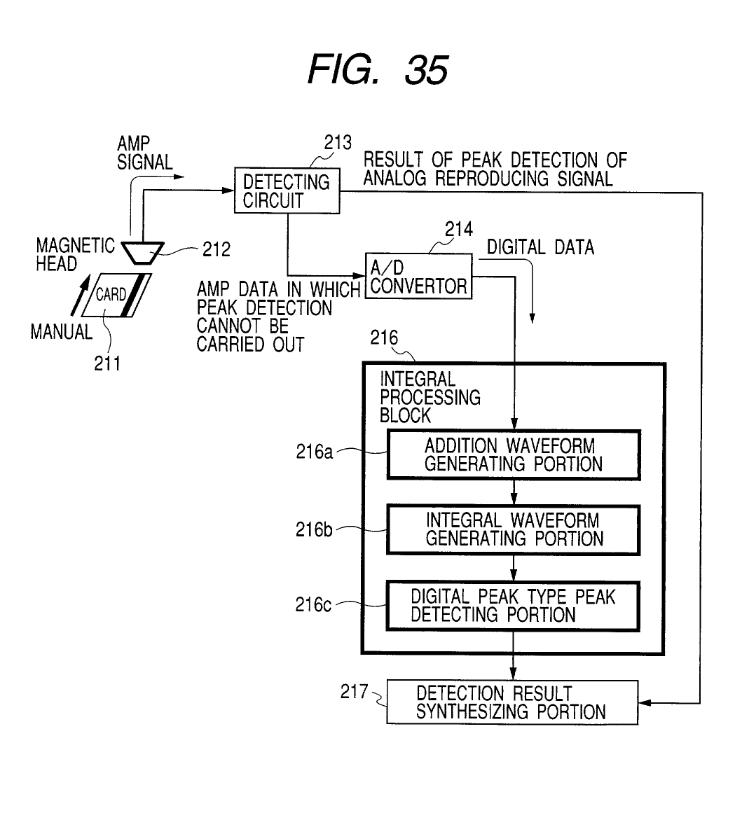

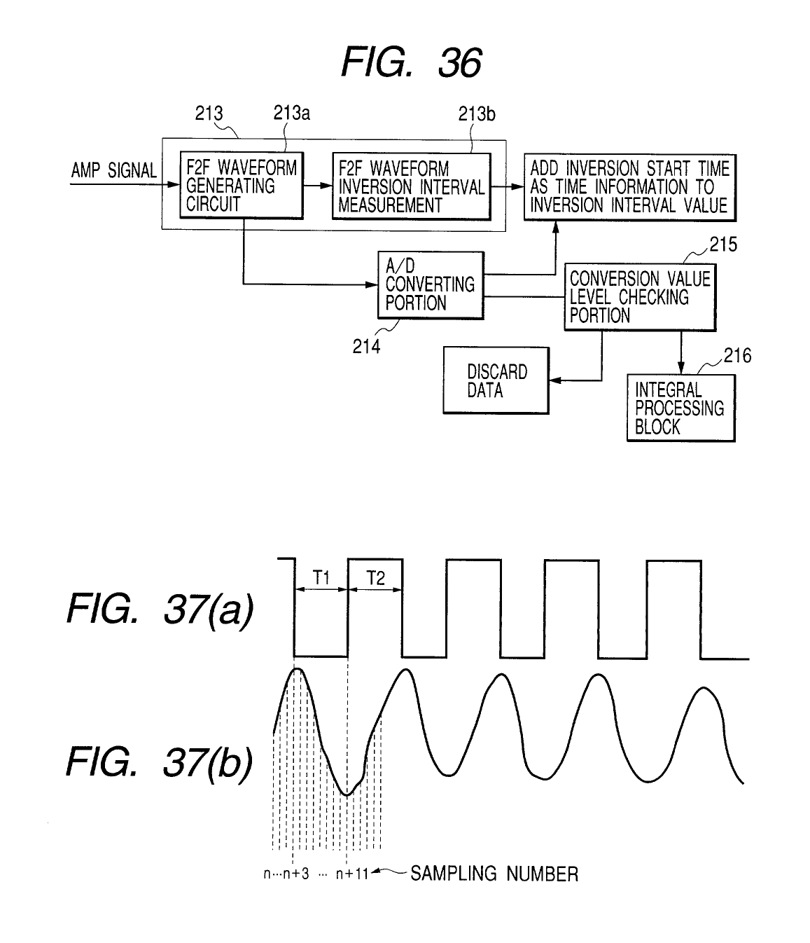

First of all, as shown in FIG. 35, magnetic recording data (see FIG. 2(a)) written to a magnetic card 11 to be a magnetic recording medium are reproduced as an analog signal (AMP signal) by means of a magnetic head 212, and the analog reproducing signal (AMP reproducing signal) is used for an F2F generating circuit 213a and an F2F waveform decision interval measuring circuit 213b which are provided in an ordinary peak detecting circuit 213 having the same structure as that of the conventional art as shown in FIG. 36, and is thus formed into a peak interval detection signal (see FIG. 2(f)) shown in FIG. 37(a).

On the other hand, the analog signal (AMP signal) sent from the magnetic head 212 is input to an A/D converter 214 and is A/D converted so that digital data (digital reproducing signal) shown in FIG. 37(b) are obtained. The digital data (digital reproducing signal ; see FIG. 37(b)) are related to the peak interval detection signal (see FIG. 37(a)) and a number is given to each sampling interval. The number is used as position information or time information at time of a synthesis which will be described below. In an example of the signal shown in FIGS. 37(a) and (b), a sampling number (n+3) in the digital data of FIG. 37(b) is related to a certain peak interval value T1 in the peak interval detection signal of FIG. 37(a), and furthermore, a sampling number (n+11) in the same digital data is given to a peak interval value T2 of the same peak interval detection signal. They are used as position and time information.

Furthermore, the digital data (digital reproducing signal) converted and output from the A/D converter 214 are input to a conversion value level checking portion 215 shown in FIG. 36 and are compared with a preset threshold therein. In the case in which there is no conversion output having a higher level than the threshold over a constant time or more, the digital data (digital reproducing signal) within the time range are output to an integral processing block 216 which will be described below so that a peak detection is carried out and other digital data are discarded. Then, a peak interval detection signal obtained in the integral processing block 16 is synthesized with a peak interval detection signal sent from the peak detecting circuit 213 in a detection result synthesizing portion 217 shown in FIG. 35, and is thereafter sent to a next processing circuit.

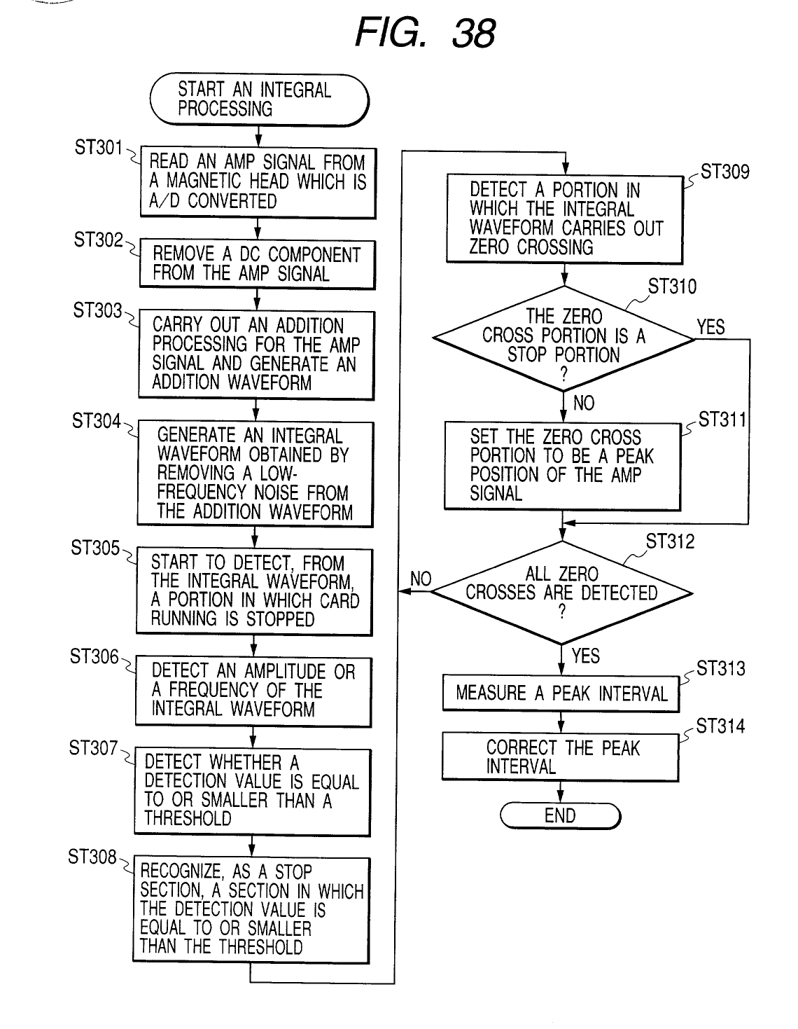

The integral processing block 216 includes an addition waveform generating portion 216a, an integral waveform generating portion 16b and a digital peak type peak detecting portion 126c, and an integral processing shown in FIG. 38 is carried out in each of the portions 216a to 216c. More specifically, when the integral processing is started in FIG. 38, the digital data within a range including no conversion output having a higher level than the threshold over a constant time or more are first fetched from the A/D converter 214 into the addition waveform generating portion 216a (a step 301 (ST 301) in FIG. 38), and a DC component is removed from the digital data (a step 302 (ST302) in FIG. 38).

Description will be given to a specific operation procedure in this case. First of all, the result of an addition for An to be an nth digital reproducing signal output from the A/D converter 214 is obtained based on a total sample number N as in the following equation, and a DC component DC is obtained from the result of the addition.

$$D C component = ( 1 / N ) {\sum }_{k = 1}^{N} {A}_{k} \qquad ( 1 )$$

Then, data an from which the DC component DC is removed are obtained in the following equation.

aₙ=Aₙ−DC (2)

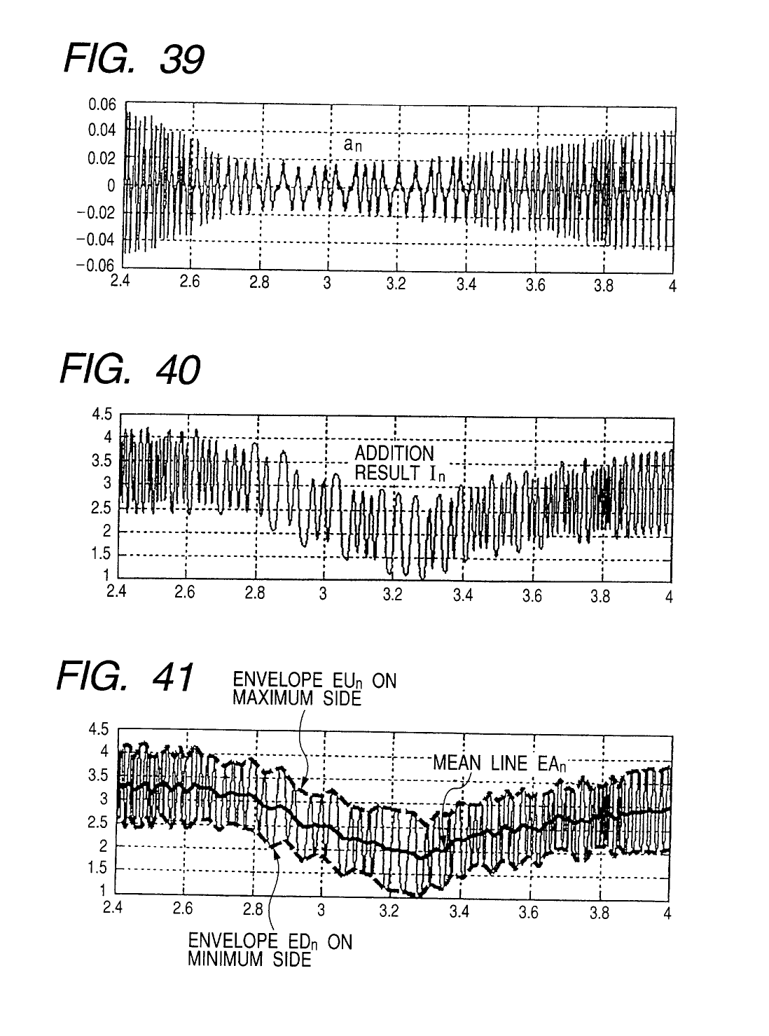

The waveform signal of the data an from which the DC component DC is removed is shown in FIG. 39, for example. In FIG. 39, an axis of abscissa indicates a sample number obtained with a multiplication by a multiplier of 10.

Next, an addition processing for the data an from which the DC component is removed is carried out so that an addition waveform In of the digital reproducing signal is obtained (a step 303 (ST303) in FIG. 38). At that time, the addition processing is carried out by the following equation, and a signal having a waveform shown in FIG. 40 is obtained.

$${I}_{n} = {\sum }_{k - 1}^{n} {a}_{k} ( n = 1 \sim N \text{:} N is total sample number ) \qquad ( 3 )$$

In the integral waveform generating portion 216b, furthermore, an integral waveform from which a low-frequency noise is removed is calculated from the addition waveform In of the digital reproducing signal (a step 304 (ST304) in FIG. 38). At this time, an envelope EUn on the maximum side and an envelope EDn on the minimum side in the addition waveform In are first obtained, and a mean line EAn of the envelopes EUn and EDn is calculated in the following equation.

EAₙ=(EUₙ+EDₙ)/2 (n=1˜N: is total sample number) (4)

These curves become waveform signals shown in FIG. 41, for example.

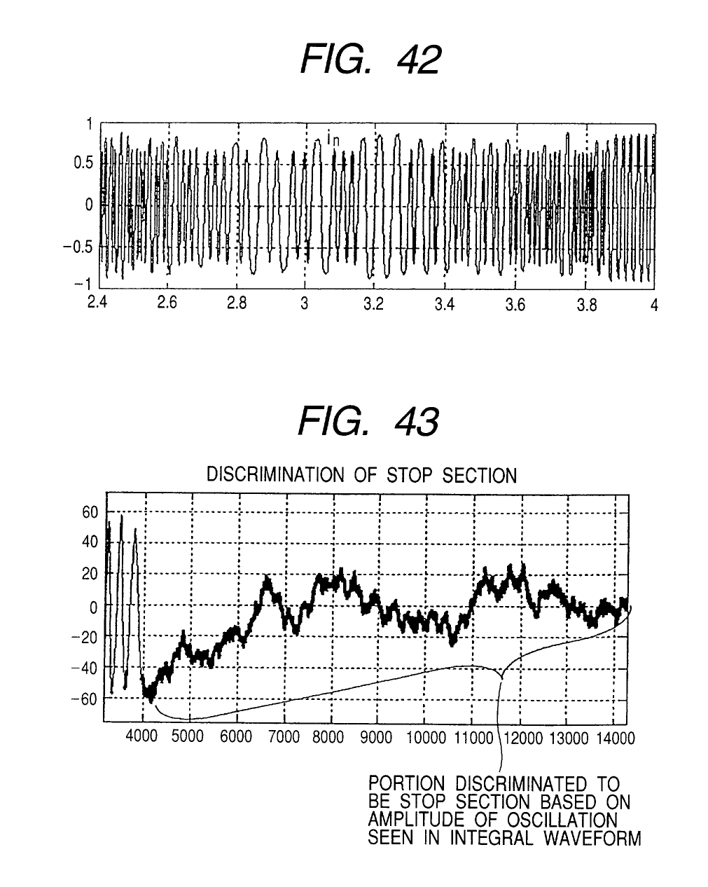

Next, an integral waveform in from which a low-frequency noise is removed is calculated from the mean line EAn of the envelopes EUn and EDn based on the following equation, and a waveform signal shown in FIG. 42 is obtained, for example.

iₙ=Iₙ−EAₙ (n=1˜N:N is total sample number) (5)

Subsequently, it is decided whether or not the stop section of the magnetic card 11 is present in the integral waveform in, and the detection of the stop section is started if any (a step 305 (ST305) in FIG. 38). In order to detect the stop section, first of all, an amplitude or a frequency of a peak fluctuation in the integral waveform in is detected (a step 306 (ST306) in FIG. 38). Then, the amplitude or frequency of the peak fluctuation thus detected is compared with a threshold corresponding to the amplitude or frequency of a peak fluctuation which is obtained when the magnetic card 211 is stopped (a step 307 (ST307) in FIG. 38). As shown in FIG. 43, for example, a section within a smaller range than the threshold is recognized as the stop section of the magnetic card 211 (a step 308 (ST308) in FIG. 38). In the embodiment, the amplitude of the peak fluctuation is set to 15 as the threshold. When an amplitude of one peak fluctuation is greater than “1” and is not greater than “15” on an axis of ordinate in FIG. 43, the stop is recognized.

On the other hand, a zero cross point in the integral waveform in corresponds to the peak position of an original digital reproducing signal. In the digital type peak detecting portion 16c, therefore, the zero cross point in the integral waveform in is detected (a step 309 (ST309) in FIG. 38). Consequently, it is decided whether or not the zero cross point in the integral waveform in thus detected is present in the stop section (a step 310 (ST310) in FIG. 38). If the zero cross point is not present in the stop section (No in a step 310 (ST310) of FIG. 38), the zero cross point is recognized as a peak position (a step 311 (ST311) in FIG. 38). If the zero cross point is present in the stop section (Yes in the step 310 (ST310) of FIG. 38), the zero cross point is not recognized as the peak position but a movement to a next zero cross point is carried out, and the same zero cross detection is executed for all the zero cross points (a step 312 (ST312) in FIG. 38). More specifically, the zero cross point present within the range of the stop section of the magnetic card 211 is disregarded and the magnetic data information is not demodulated.

The presence in the stop section is detected for all the zero cross points. Referring to a position corresponding to the zero cross point recognized to be the peak position as described above, then, a peak interval between the peak positions of the digital reproducing signal is measured (a step 313 (ST313) in FIG. 38) so that a peak interval detection signal is output.

When the peak interval is to be measured, an error constant ±α of a noise in the vicinity of “0” is set in consideration of a variation in a waveform. For the error constant ±α, a peak position is set corresponding to the following equation.

iₙ₋₁≦0+α and iₙ [symbol] 0+α

or

iₙ₋₁≧0+α and iₙ [symbol] 0+α (6)

Finally, the peak interval detection signal comprising the integral waveform obtained as described above is synthesized with the peak interval detection signal sent from the peak detecting circuit 213 having the ordinary structure described above, and a correction is carried out (a step 314 (ST314) in FIG. 38). Thus, the integral processing is ended.

In the embodiment, thus, the peak detection is carried out at a detectable level by using the signal obtained by integrating the digitized reproducing signal. Also in the case in which the passage speed of the magnetic recording medium such as a magnetic card is reduced so that the detection cannot be carried out as in the conventional art, therefore, the peak detection can be performed well. At this time, moreover, the stop section of the magnetic card 211 is discriminated depending on the amplitude or cycle of the peak fluctuation in the integral waveform. In the section to be discriminated as the stop section, the magnetic data information is not demodulated. Consequently, the peak of the magnetic recording data can be detected accurately irrespective of the stop section. Thus, the erroneous detection of a character can be prevented well.

In the embodiment, moreover, a low-frequency signal is not uniformly cut in the integral calculation but only a low-frequency noise is removed based on a mean value obtained by using an envelope indicative of the result of the integral. In the case in which a peak interval is greatly enlarged, particularly, the peak detection can be carried out well.

In the embodiment, furthermore, the processing is carried out for only a range in which the detection cannot be performed by the conventional method. Therefore, a whole time required for the peak detection can be shortened. Moreover, the mean value is calculated by using the envelope of the integral waveform. Consequently, the operation processing can be carried out more rapidly and a whole processing speed can be enhanced.

In addition, in the embodiment, the digital type peak detecting portion 216c detects the zero cross point of a mean integral curve output from the integral waveform generating portion 16b, thereby carrying out the peak detection. Consequently, the processing can be performed rapidly and accurately. In the embodiment, moreover, the level of the digital reproducing signal is detected in the conversion value level checking portion 215 and the digital reproducing signal corresponding to a range in which the level is lower than a threshold over a constant time is sent to the addition waveform generating portion 216. Consequently, the processing is carried out for only the signal within such a range that the detection cannot be performed by the conventional method. Thus, the whole time required for the peak detection can be shortened still more.

In the embodiment, furthermore, there is provided the means for adding position information or time information to the digital reproducing signal within such a range as to be less than the threshold. By using the position information or the time information, therefore, the synthesis of the result of the peak detection based on the analog reproducing signal and the result of the peak detection based on the digital reproducing signal can be carried out rapidly and accurately.

While the embodiment according to the invention made by the inventor has been specifically described above, the invention is not restricted to the embodiment but it is apparent that the invention can be variously changed without departing from the scope thereof.

For example, the position detected as the stop section of the magnetic card can be used for the decision of the peak detection, and furthermore, can also be used for recognizing the position of an error character in a processing of specifying a character utilizing a peak interval.

In the embodiment, moreover, the mean line EAn of the addition waveform In to be used for removing the low-frequency noise from the addition waveform In of the digital reproducing signal to acquire an integral waveform is obtained by calculating the envelopes EUn and EDn of the addition waveform In. The envelope does not need to be obtained, and various operation methods can be employed, for example, a mean value of adjacent maximum and minimum points is obtained to form a mean line.

Furthermore, while the zero cross point in the integral waveform in is detected as the peak position in the embodiment, the peak position can also be detected under other various conditions, for example, a portion having the greatest gradient is detected.

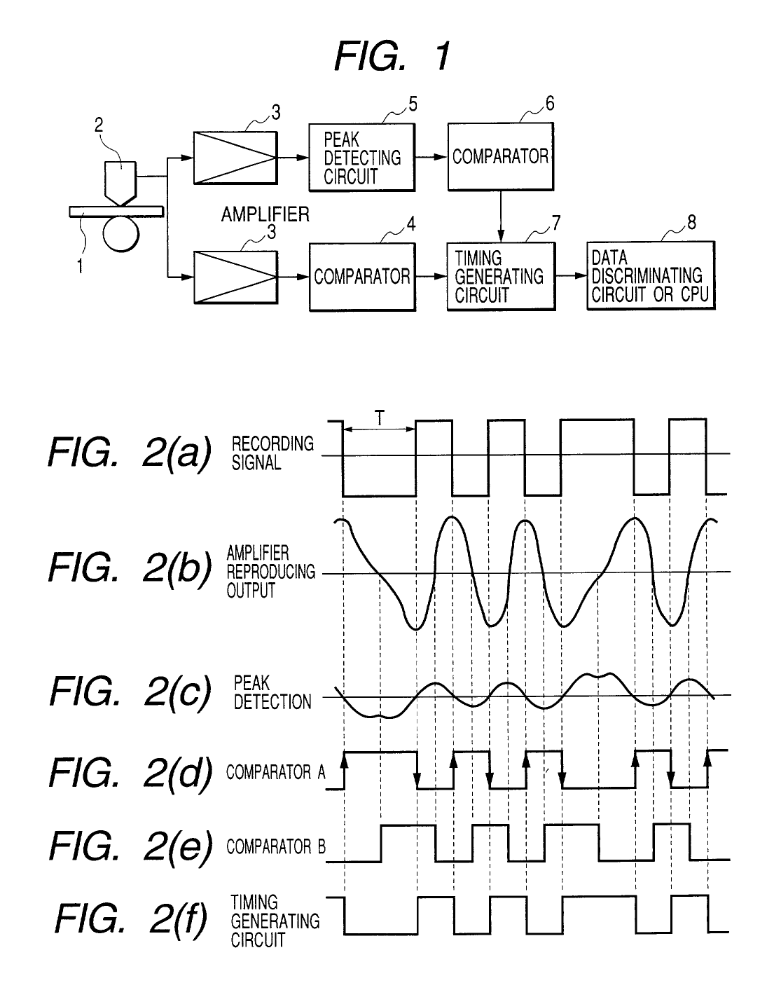

FIG. 1

4: Comparator

5: Peak detecting circuit

6: Comparator

7: Timing generating circuit

8: Data discriminating circuit or CPU

FIG. 2(a) Recording signal

FIG. 2(b) Amplifier reproducing output

FIG. 2(c) Peak detection

FIG. 2(e) Comparator A

FIG. 2(f) Comparator B

FIG. 2(g) Timing generating circuit

FIG. 4

A: Processing of detecting peak of AMP signal

B: Measurement of peak interval

C: Data demodulating block

D: Time pattern matching processing

E: Error character estimation processing

F: Report of result to user

G: Display of result on display device

H: Transmission of result to upper application

the bit of the estimation character

S116 All the error characters are completely constructed normally?

S117 Demodulation success

FIG. 8

A: Bit follow-up from front part

B: Start bit follow-up by using these two points

C: Frequency at which 1F/2F decision is first carried out

FIG. 9

A: Calculation of bit frequency

B: Two points represent bit 1

C: This frequency is reduced to half for bit 1

D: This point represents bit 0

FIG. 10

A: Prediction of bit frequency

B: Frequency at which 1F/2F decision is carried out

C: Two points to be used for prediction of bit frequency

D: Median value of bit prediction value

E: Range of bit frequency prediction value

F: ½ of frequency at which 1F/2F decision is carried out

G: This frequency is decided to be 2F because of ½ value within bit frequency prediction value range

FIG. 11

A: Bit follow-up from rear part

B: Frequency at which 1F/2F decision is first carried out by bit follow-up from rear part

C: Start bit follow-up from rear part by using these two points

FIG. 12

A: Application of 1F/2F decision for all error characters

B: Frequency decided to be 2F

C: Frequency decided to be 1F

D: Frequency decided to be 2F

E: Frequency decided to be 1F

FIG. 13

A: Bit decision of error character 1

B: 1F/2F decision is disabled

FIG. 14

A: Bit decision of error character 2

B: This point is decided to be 2F and is error bit because another 2F to be paired is not present

C: 1F/2F decision is disabled

FIG. 15

A: Create temporary normal character

B: Portion which can be discriminated by error character 1

C: Portion which can be discriminated by error character 2

D: Temporary normal character

FIG. 16

A: Calculation of estimation character

B: Exclude parity portion

C: Exclusive OR of all normal characters

D: LRC (horizontal redundant code)

E: Temporary normal character

F: Calculation of estimation character

G: Estimation character

FIG. 17

A: Estimation character

B: Error character 1

C: Bit interpolation of error character

D : Error character 1 . . . character

E: Interpolated portion

F: Calculate parity

FIG. 18

A: Estimation character

B: Error character 2

C: Bit interpolation of error character

D: Error character 2 . . . Estimated to be character ‘W’

FIG. 19

A: Processing of detecting peak of AMP signal

B: Measurement of peak interval

C: Data demodulating block

D: Normalization of peak interval

E: Time pattern matching processing

F: Error character estimation processing

G: Report of result to user

H: Display of result on display device

I: Transmission of result to upper application

FIG. 20

A: Original AMP signal waveform

FIG. 21

A: AMP signal waveform and envelope thereof (enlarged middle part)

FIG. 22

A: Envelope (whole)

FIG. 23

A: Envelope of AMP signal waveform having data number reduced to 1000 (track 1)

FIG. 24

Envelope of AMP signal waveform having data number reduced to 1000 (track 2)

FIG. 25

A: Envelope of AMP signal waveform having data number reduced to 1000 (track 3)

FIG. 26

A: Speed curve obtained by synthesizing envelope of each track (waveform shaping with maximum value set to 1)

FIG. 27

A: Speed curve having data number increased to AMP signal data number

FIG. 28

A: Peak interval of AMP signal

FIG. 29

A: Mean speed of peak of AMP signal

FIG. 30

A: Normalized peak interval

FIG. 31

A: Head peak interval of section A

B: Head peak interval of section B

C: Normalized peak interval

FIG. 32

Peak interval No.

Peak interval value

Peak interval No.

Peak interval value

FIG. 33

A: Head peak interval of section A

B: Head peak interval of section B

C: Head peak interval of section C

D: Normalized peak interval value

FIG. 34

A: Peak interval number determination processing of error character

(ST201) Set 1 to the estimated peak interval number of an error character

(ST202) The estimated peak interval number of the error character is a maximum value?

(ST203) Shift the estimated head peak interval of a section B from the head peak interval of a section A by the estimated peak interval number of the error character

(ST204) Start a time pattern matching processing from the estimated head peak interval of the section B

(ST205) A character having a high correlation is present?

(ST206) Record the estimated peak interval number of the error characters and the number of normal characters in the error characters having the same interval number

(ST207) Increase the estimated peak interval number of the error character by one

(ST208) Count the number of normal characters

(ST209) Execute the time pattern matching processing by setting a position shifted by the peak interval number of a character having a high correlation to be the head peak interval of a next section

(ST210) There is an estimated peak interval number at which the number of normal characters is equal to or greater than a predefined number?

(ST211) Employ the estimated peak interval number

(ST212) Employ the peak interval number of the character having the highest correlation in the time pattern matching processing for the error character

(ST213) Set the employed peak interval number to be the peak interval number of the error character

FIG. 35

A: Result of peak detection of analog reproducing signal

B: AMP data in which peak detection cannot be carried out

C: Integral processing block

D: Addition waveform generating portion

E: Integral waveform generating portion

F: Digital peak type peak detecting portion

G: Detection result synthesizing portion

FIG. 36

213a: F2F waveform generating circuit

213b: F2F waveform inversion interval measurement

214: A/D converting portion

215: Conversion value level checking portion

216: Integral processing block

A: Add inversion start time as time information to inversion interval value

FIG. 38

A: Start an integral processing

ST301: Read an AMP signal from a magnetic head which is A/D converted

ST301: Remove a DC component from the AMP signal

ST303: Carry out an addition processing for the AMP signal and generate an addition waveform

ST304: Generate an integral waveform obtained by removing a low-frequency noise from the addition waveform

ST305: Start to detect, from the integral waveform, a portion in which card running is stopped

ST306: Detect an amplitude or a frequency of the integral waveform

ST307: Detect whether a detection value is equal to or smaller than a threshold

ST308: Recognize, as a stop section, a section in which the detection value is equal to or smaller than the threshold

ST309: Detect a portion in which the integral waveform carries out zero crossing

ST310: The zero cross portion is a stop portion?

ST311: Set the zero cross portion to be a peak position of the AMP signal

ST312: All zero crosses are detected?

ST313: Measure a peak interval

ST314: Correct the peak interval

FIG. 43

A: Discrimination of stop section

B: Portion discriminated to be stop section based on amplitude of oscillation seen in integral waveform

FIG. 5

A: Inverse number of interval (frequency)

B: Error character

C: Error character

FIG. 6

S101 Processing of estimating a plurality of characters

S102 Detect two or more error characters

S103 Specify the error character to be decided

S104 A character before a current error character is a normal character?

S105 Bit follow-up processing from a front part

S106 An interval value which cannot be decided is detected?

S107 A character after the current error character is a normal character?

S108 Bit follow-up processing from a rear part

S109 An interval value which cannot be decided is detected?

S110 The bit follow-up processing for all the error characters is ended?

S111 Construct a temporary normal character

S112 Number of temporary normal characters=number of error characters·1

S113 Calculate an estimation character

S114 Demodulation failure

S115 Combination of the decision bit of each error character and

What is claimed is:

1. A data demodulating method for magnetic recording data which reproduces magnetic recording data written to a magnetic recording medium and continuously demodulates a plurality of characters constituted by a plurality of bit signals having “0” and “1” based on a peak interval obtained by timing a time interval between peak positions in a reproducing signal of the magnetic recording data, thereby obtaining magnetic data information, comprising the steps of:
discriminating the demodulated characters into normal characters having only proper bit signals which are demodulated properly and error characters at least partially including improper bit signals which are not demodulated properly;
estimating each of the improper bit signals constituting the error characters by using the proper bit signals constituting the normal characters if the error characters are generated in a plurality of portions; and
calculating the improper bit signals which cannot be estimated in one error character by using estimation bit signals capable of carrying out the estimation for other error characters, thereby discriminating all the error characters.

2. The data demodulating method for magnetic recording data according to claim 1, wherein the improper bit signal in the error character is estimated based on proper bit signals in normal characters adjacent to front and rear parts of the error character.

3. The data demodulating method for magnetic recording data according to claim 2, wherein the improper bit signal in the error character is estimated by a bit follow-up method using a plurality of normal bit signals or estimation bit signals which are adjacent to the improper bit signal.

4. The data demodulating method for magnetic recording data according to claim 3, wherein an operation is carried out to adapt a plurality of adjacent bit signals to be used for the estimation of the improper bit signal in the error character to either of bit signals of “0” and “1”.

5. The data demodulating method for magnetic recording data according to claim 1, wherein when the improper bit signal which cannot be estimated in the error character is to be calculated by using the estimation bit signals in the other error characters, an operation is carried out based on a fact that a total number of bit signals of “1” in the same rank in all the characters is a predetermined even or odd number.

6. The data demodulating method for magnetic recording data according to claim 1, wherein if a parity bit is not estimated with the characters from which the error characters are discriminated, the parity bit is calculated based on a relationship with other estimation bit signals in the discriminated characters.

7. The data demodulating method for magnetic recording data according to claim 1, wherein if the parity bit is estimated with the characters from which the error characters are discriminated, other estimation bit signals are checked by using the parity bit.

8. A data demodulating method for magnetic recording data which relatively moves a magnetic recording medium and a magnetic head to reproduce magnetic recording data written to the magnetic recording medium, detects a peak position in a reproducing signal of the magnetic recording data and then demodulates magnetic data information having “0” and “1” signals based on peak interval data obtained by timing a time interval between adjacent peak positions thus detected, comprising the steps of:
sequentially connecting the adjacent peak positions in the reproducing signal of the magnetic recording data, thereby calculating a peak envelope;
obtaining a speed curve corresponding to a relative moving speed of the magnetic recording medium and the magnetic head by using the peak envelope;
calculating a mean speed of the peak positions in the reproducing signal of the magnetic recording data based on the speed curve;
normalizing peak position interval data in the reproducing signal of the magnetic recording data by using the mean speed of the peak positions; and
demodulating magnetic data information having the “0” and “1” signals based on peak interval data obtained by the normalization.

9. The data demodulating method for magnetic recording data according to claim 8, wherein the number of data on the peak position in the reproducing signal of the magnetic recording data is reduced to carry out a reduction processing in order to calculate the peak envelope.

10. The data demodulating method for magnetic recording data according to claim 9, wherein a speed curve obtained by using the peak envelope subjected to the reduction processing is enlarged to have the number of data on an original peak position, thereby carrying out an interpolation processing.

11. The data demodulating method for magnetic recording data according to claim 10, wherein the interpolation processing is carried out by a tertiary convolution interpolating method.

12. A method of detecting a stop section of a magnetic recording medium in which magnetic recording data written to a magnetic recording medium are reproduced by a relative movement of the magnetic recording medium and a magnetic head, comprising the steps of:
carrying out an integral calculation of a reproducing signal of the magnetic recording data, thereby obtaining an integral waveform; and
detecting an amplitude or a cycle of a peak fluctuation in the integral waveform and deciding, as a stop section of the relative movement, a range in which the amplitude or cycle of the peak fluctuation thus detected is smaller than a threshold corresponding to an amplitude or a cycle of a peak fluctuation obtained when the relative movement of the magnetic recording medium and the magnetic head is stopped.

13. A data demodulating method for magnetic recording data in which magnetic recording data written to a magnetic recording medium are reproduced by a relative movement of the magnetic recording medium and a magnetic head, and a peak position in a reproducing signal of the magnetic recording data is detected and magnetic data information having a “0” signal or a “1” signal is demodulated based on peak interval data obtained by timing a time interval between the peak positions, comprising the steps of:
carrying out an integral calculation of a reproducing signal of the magnetic recording data, thereby obtaining an integral waveform;
detecting an amplitude or a cycle of a peak fluctuation in the integral waveform and deciding, as a stop section of the relative movement, a range in which the amplitude or cycle of the peak fluctuation thus detected is smaller than a threshold corresponding to an amplitude or a cycle of a peak fluctuation obtained when the relative movement of the magnetic recording medium and the magnetic head is stopped; and
carrying out no demodulation over the magnetic data information in the stop section.

14. The data demodulating method for magnetic recording data according to claim 13, wherein in the demodulation of the magnetic data information based on the integral waveform, a zero cross point of the integral waveform is detected as a peak position in the reproducing signal of the magnetic recording data.

15. The data demodulating method for magnetic recording data according to claim 13, wherein the magnetic data information is demodulated based on the integral waveform of the reproducing signal of the magnetic recording data in such a range that the reproducing signal of the magnetic recording data is smaller than a properly determined output level.

16. The data demodulating method for magnetic recording data according to claim 13, wherein in the demodulation of the magnetic data information based on the integral waveform, first of all, the reproducing signal of the magnetic recording data is A/D converted to obtain a reproduction curve of digital data, an integral calculation for the digital data forming the reproduction curve is carried out to obtain an integral waveform, a curve representing a mean value of the integral waveform is then obtained by using a maximum value and a minimum value in the integral waveform, a mean integral curve is further obtained by subtracting the mean value from the value of the integral waveform, and a zero cross point of the mean integral curve is detected as a peak position in the reproducing signal of the digital data, thereby demodulating the magnetic data information.

17. The data demodulating method for magnetic recording data according to claim 13, wherein an envelope on a maximum side and an envelope on a minimum side are obtained by using a maximum value and a minimum value in the integral waveform respectively, and a mean value of the integral waveform is obtained by using the envelope on the maximum side and the envelop on the minimum side.
